(19) United States
(12) Patent Application Publication
(10) Pub. No.: US 2021/0170492 A1
(43) Pub. Date: Jun. 10, 2021

(54) ADDITIVE MANUFACTURING METHOD OF JOINT OBJECT AND JOINT MEMBER

(71) Applicant: MITSUBISHI HEAVY INDUSTRIES, LTD., Tokyo (JP)

(72) Inventors: Takahiro TACHIBANA, Tokyo (JP); Yasuyuki FUJIYA, Tokyo (JP)

(21) Appl. No.: 17/178,622

(22) Filed: Feb. 18, 2021

Related U.S. Application Data
(63) Continuation of application No. PCT/JP2019/034954, filed on Sep. 5, 2019.

(30) Foreign Application Priority Data
Sep. 13, 2018 (JP) 2018-171127

(51) Int. Cl. B22F 10/28; B22F 12/41; B33Y 10/00

(52) U.S. Cl. CPC B22F 10/28; B33Y 70/00; B33Y 10/00; B22F 12/41

(57) ABSTRACT

An additive manufacturing method according to at least one embodiment includes a step of forming a first layer by melting and solidifying powder of a first metal, and a step of forming a second layer on the first layer by melting and solidifying powder of a second metal of a different type from the first metal. The first metal and the second metal are, if the first metal is added to the second metal, a combination capable of forming a solid solution, or if the first metal is added to the second metal, a combination raising a melting point as an additive amount of the first metal increases.

### TECHNICAL FIELD

The present disclosure relates to an additive manufacturing method of a joint object and a joint member.

### BACKGROUND

In recent years, three-dimensional additive manufacturing is used as a manufacturing method of various products. Moreover, for example, it is disclosed that a joint member where materials of different types are joined is obtained in an additive manufacturing method by an LMD (Laser Metal Deposition) method (see Patent Document 1).

### CITATION LIST

### Patent Literature

Patent Document 1: WO2017/110001A

### SUMMARY

### Technical Problem

For example, if additive manufacturing is performed by the LMD method, on a surface of a member made of one metal (first metal), powder of another metal (second metal) is melted and solidified to form a layer of the second metal, thereby it is possible to obtain a joint member where metallic materials of different types are joined.

However, depending on types of metals, a fragile area by an intermetallic compound of the first metal and the second metal is generated at a joint interface of the metallic materials of the different types. If the fragile area is generated at the joint interface of the metallic materials of the different types, a joint strength at the joint interface is decreased, decreasing a strength of the joint member.

In view of the above, an object of at least one embodiment of the present invention is to suppress the decrease in strength of the joint member where the metallic materials of the different types are joined.

### Solution to Problem

(1) An additive manufacturing method of a joint object according to at least one embodiment of the present invention includes a step of forming a first layer by melting and solidifying powder of a first metal, and a step of forming a second layer on the first layer by melting and solidifying powder of a second metal of a different type from the first metal. The first metal and the second metal are, if the first metal is added to the second metal, a combination capable of forming a solid solution, or if the first metal is added to the second metal, a combination raising a melting point as an additive amount of the first metal increases.

If the melted second metal adheres to the surface of the first layer, a part of the first layer is melted and mixed into the melted second metal. Thus, as described above, depending on the types of the first metal and the second metal, a fragile area by an intermetallic compound of the first metal and the second metal is generated.

In this regard, with the above method (1), the first metal and the second metal are the combination capable of forming the solid solution as described above, or the combination raising the melting point as described above.

As long as the first metal and the second metal are the combination capable of forming the solid solution as described above, it is possible to generate not the intermetallic compound but the solid solution of the first metal and the second metal, even if the first metal is mixed into the melted second metal in the forming of the second layer. Thus, it is possible to suppress formation of the fragile area by the intermetallic compound, making it possible to suppress a decrease in strength of a joint member of the first metal and the second metal.

Moreover, as long as the first metal and the second metal are the combination raising the melting point as described above, a melting point in a mixed portion of the first metal and the second metal increases relative to a melting point of the second metal, solidifying the mixed portion, if the first metal is mixed into the melted second metal in the forming of the second layer. Consequently, the layer (mixed layer) obtained by solidifying the mixed portion of the first metal and the second metal is formed between the first layer and the melted second metal. Thus, since the mixed layer suppresses mixture of the first metal from the first layer to the melted second metal, it is possible to suppress formation of the fragile area by the intermetallic compound, and to suppress the decrease in strength of the joint member of the first metal and the second metal.

(2) In some embodiments, in the above method (1), the first metal and the second metal are selected, which are the combination capable of forming the solid solution or the combination raising the melting point.

With the above method (2), since the first metal and the second metal are the combination capable of forming the solid solution as described above or the combination raising the melting point as described above, it is possible to suppress formation of the fragile area by the intermetallic compound in the vicinity of the interface between the first layer and the second layer, and to suppress the decrease in strength of the joint member of the first metal and the second metal.

(3) In some embodiments, in the above method (1) or (2), the step of forming the second layer includes forming the second layer on a processing condition in which a content of the first metal in the second layer is not more than a limit capable of forming the solid solution.

With the above method (3), it is possible to generate not the intermetallic compound but the solid solution of the first metal and the second metal, even if the first metal is mixed into the melted second metal. Thus, it is possible to suppress formation of the fragile area by the intermetallic compound, making it possible to suppress the decrease in strength of the joint member of the first metal and the second metal.

(4) In some embodiments, in any one of the above methods (1) to (3), the additive manufacturing method of the joint object further includes a step of forming a second metallic part composed of the second metal, a step of forming a first metallic part composed of the first metal on the second metallic part, and a step of forming a coupling part including a first region and a second region, for coupling the first metallic part and the second metallic part by the first region and the second region, the first region being a region in which a plurality of first layers are laminated and connected to the first metallic part, the second region being a region in which a plurality of second layers are laminated and connected to the second metallic part. The step of forming the coupling part includes forming the first region and the second region such that a part of the second region is positioned above a part of the first region.

With the above method (4), since the first region and the second region are formed such that the part of the second region is positioned above the part of the first region in the coupling part, a stress acts on the first region and the second region such that the above-described part of the first region and the above-described part of the second region are pressed toward each other, even if a pulling force acts in a direction in which the first metallic part and the second metallic part are separated from each other, in the joint member where the first metallic part is formed on the second metallic part. Therefore, the above-described part of the first region and the above-described part of the second region restrict movement of the first metallic part and the second metallic part in the direction in which they are separated from each other.

Thus, since the first metallic part and the second metallic part can be coupled by mechanically coupling the first region and the second region, it is possible to improve not only the joint strength at the interface between the first metal and the second metal but also the strength of the joint member of the first metal and the second metal.

(5) In some embodiments, in the above method (4), the step of forming the coupling part includes forming the second region such that a shape thereof as viewed from a lamination direction of the plurality of second layers is an oval shape or a polygonal shape.

In the step of forming the coupling part, in a case in which the second region is formed to be a rotor as in a case in which the second region is formed such that the shape thereof as viewed from the lamination direction of the plurality of second layers is, for example, a circular shape, if the joint strength at the interface between the first metal and the second metal is not sufficient, the first metallic part and the second metallic part may rotate each other about the center axis of the rotor.

In this regard, with the above method (5), forming the second region such that the shape thereof as viewed from the lamination direction of the plurality of second layers is the oval shape or the polygonal shape, it is possible to suppress the mutual rotation of the first metallic part and the second metallic part as described above, even if the joint strength at the interface between the first metal and the second metal is not sufficient. Therefore, with the above method (5), it is possible to improve the strength of the joint member of the first metal and the second metal.

(6) In some embodiments, in the above method (4) or (5), the step of forming the coupling part includes forming the coupling part at each of a plurality of positions which are different positions as viewed from a lamination direction of the plurality of second layers.

In the step of forming the coupling part, in a case in which the second region having, for example, the circular shape as viewed from the above, that is, the lamination direction of the plurality of second layers is formed only at one spot, if the joint strength at the interface between the first metal and the second metal is not sufficient, the first metallic part and the second metallic part may rotate each other about the center axis of the rotor.

In this regard, with the above method (6), since the coupling part is formed at each of the plurality of positions which are the different positions as viewed from the lamination direction of the plurality of second layers, as described above, it is possible to suppress the mutual rotation of the first metallic part and the second metallic part. Therefore, with the above method (6), it is possible to improve the strength of the joint member of the first metal and the second metal.

(7) In some embodiments, in the above method (6), the step of forming the coupling part includes forming the coupling part at each of at least three spots which are positions not in a same straight line as viewed from the lamination direction of the plurality of second layers.

In the step of forming the coupling part, in the case in which the plurality of coupling parts are formed so as to exist in the same straight line as viewed from the lamination direction of the plurality of second layers, if the joint strength at the interface between the first metal and the second metal is not sufficient, the strength of the joint member may be insufficient with respect to a bending stress acting along a surface orthogonal to the straight line.

In this regard, with the above method (7), since the coupling part is formed at each of the at least three spots which are the positions not in the same straight line as viewed from the lamination direction of the plurality of second layers, it is possible to suppress the insufficient strength of the joint member with respect to the bending stress. Therefore, with the above method (7), it is possible to improve the strength of the joint member of the first metal and the second metal.

(8) In some embodiments, in any one of the above methods (4) to (7), the step of forming the coupling part includes forming a plurality of stages of coupling parts along a lamination direction of the plurality of second layers.

With the above method (8), since the plurality of stages of the coupling parts are formed along the lamination direction of the plurality of second layers, it is possible to improve the mechanical coupling strength between the first metallic part and the second metallic part.

(9) In some embodiments, in the above method (8), the step of forming the coupling part includes forming the second region such that a cross-sectional area of a cross-section orthogonal to the lamination direction of the plurality of second layers of the second region in the coupling parts formed by the plurality of stages gradually decreases upward along the lamination direction.

With the above method (9), the cross-sectional area of the cross-section orthogonal to the lamination direction of the plurality of second layers of the second region in the coupling parts formed by the plurality of stages gradually decreases upward along the lamination direction. In other words, the above-described cross-sectional area of the second region gradually increases downward, that is, toward the second metallic part along the lamination direction.

In the coupling parts formed by the plurality of stages, if the first metallic part and the second metallic part are pulled in the direction in which they are separated from each other, the coupling part formed at a position close to the second metallic part bears, in addition to a load acting on itself, a load acting on the coupling part formed at a position farther away from the second metallic part than itself. Thus, in terms of the strength of the coupling parts, the cross-sectional area of the cross-section orthogonal to the lamination direction of the plurality of second layers of the second region in the coupling parts desirably increases toward the second metallic part.

In this regard, with the above method (9), since the above-described cross-sectional area of the second region gradually increases toward the second metallic part, it is possible to ensure the strength of the coupling parts formed by the plurality of stages.

(10) In some embodiments, in any one of the above methods (4) to (9), the second region includes a second lower region formed on the second metallic part, in which a cross-sectional area of a cross-section orthogonal to a lamination direction of the second region is smaller than a cross-sectional area of the second metallic part, and a second upper region which is formed on the second lower region, is smaller than the cross-sectional area of the second metallic part, and is larger than a cross-sectional area of the second lower region, the first region includes a first lower region surrounding the second lower region from a direction orthogonal to the lamination direction, and the step of forming the coupling part includes forming the first lower region before forming the second lower region.

With the above method (10), since the first lower region is formed before the second lower region is formed, the first metal from the first lower region may be mixed into the melted second metal in the forming of the second lower region. However, the combination of the first metal and the second metal in the above method (10) is the combination by the above method (1), as in the above method (4).

Therefore, as long as the first metal and the second metal are the combination capable of forming the solid solution as described above, it is possible to generate not the intermetallic compound but the solid solution of the first metal and the second metal, even if the first metal from the first lower region is mixed into the melted second metal in the forming of the second lower region. Thus, it is possible to suppress formation of the fragile area by the intermetallic compound, making it possible to suppress the decrease in strength of the joint member of the first metal and the second metal.

Moreover, as long as the first metal and the second metal are the combination raising the melting point as described above, the melting point in the mixed portion of the first metal and the second metal increases relative to the melting point of the second metal, solidifying the mixed portion, if the first metal is mixed into the melted second metal in the forming of the second lower region. Consequently, the layer (mixed layer) obtained by solidifying the mixed portion of the first metal and the second metal is formed between the first lower region and the melted second metal. Thus, since the mixed layer suppresses mixture of the first metal from the first lower region to the melted second metal, it is possible to suppress formation of the fragile area by the intermetallic compound, and to suppress the decrease in strength of the joint member of the first metal and the second metal.

(11) In some embodiments, in the above method (10), the step of forming the coupling part includes forming the second lower region at a position away from the first lower region first, in the forming of the second lower region.

With the above method (11), since the second lower region is formed from the position away from the first lower region first in the forming of the second lower region, it is possible to suppress expansion of a region, into which the first metal derived from the first lower region is mixed, in the second lower region.

(12) In some embodiments, in the above method (10) or (11), the step of forming the coupling part includes laminating the first layer at a position of a same height as the first layer and away from the second upper region first, before forming the first layer on top of the second upper region.

With the above method (12), it is possible to narrow a range of the first layer into which the second metal derived from the second upper region is mixed.

(13) In some embodiments, in any one of the above methods (4) to (12), the step of forming the coupling part includes forming the coupling part such that a third region is interposed between the first region and the second region, the third region including a plurality of laminated third layers obtained by melting and solidifying powder of a third metal of a different type from the first metal and the second metal.

If linear expansion coefficients are different between the first metal and the second metal, a thermal stress is generated in the vicinity of an interface where the first metal and the second metal contact, due to a temperature change of the joint member. Thus, in a case in which the difference in linear expansion coefficient between the first metal and the second metal is large, a value of the generated thermal stress is large as compared with a case in which the difference in linear expansion coefficient is small, easily decreasing the joint strength between the first metal and the second metal.

In this regard, with the above method (12), since the coupling part is formed such that the third region composed of the third metal is interposed between the first region and the second region, it is possible to mitigate the thermal stress in the first region and the second region by, for example, selecting, as the third metal, a metal having a linear expansion coefficient of a value between the linear expansion coefficient of the first metal and the linear expansion coefficient of the second metal, or selecting a soft metal. Thus, it is possible to suppress the decrease in strength of the joint member.

(14) In some embodiments, in the above method (13), the first metal, the second metal, and the third metal are any one of, if one metal of the first metal or the third metal is added to the other metal, a combination capable of forming a solid solution, if one metal of the second metal or the third metal is added to the other metal, a combination capable of forming a solid solution, if one metal of the first metal or the third metal is added to the other metal, a combination raising a melting point as an additive amount of the other metal increases, or if one metal of the second metal or the third metal is added to the other metal, a combination raising a melting point as an additive amount of the other metal increases.

With the above method (14), it is possible to suppress formation of the fragile area by the intermetallic compound in the vicinity of the interface between the first metal and the third metal and the vicinity of the interface between the second metal and the third metal, making it possible to suppress the decrease in strength in the vicinity of the interface.

(15) An additive manufacturing method of a joint object according to at least one embodiment of the present invention includes a step of forming a fourth metallic part composed of a fourth metal, a step of forming a fifth metallic part composed of a fifth metal of a different type from the fourth metal on the fourth metallic part, and a step of forming a coupling part including a fourth region and a fifth region, for coupling the fourth metallic part and the fifth metallic part by the fourth region and the fifth region, the fourth region being a region, in which a plurality of fourth layers obtained by melting and solidifying powder of the fourth metal are laminated, and connected to the fourth metallic part, the fifth region being a region, in which a plurality of fifth layers obtained by melting and solidifying powder of the fifth metal are laminated, and connected to the fifth metallic part. The step of forming the coupling part includes forming the fourth region and the fifth region such that a part of the fourth region is positioned above a part of the fifth region.

With the above method (15), since the fourth region and the fifth region are formed such that the part of the fourth region is positioned above the part of the fifth region in the coupling part, a stress acts on the fourth region and the fifth region such that the above-described part of the fourth region and the above-described part of the fifth region are pressed toward each other, even if a pulling force acts in a direction in which the fourth metallic part and the fifth metallic part are separated from each other, in the joint member where the fifth metallic part is formed on the fourth metallic part. Therefore, the above-described part of the fourth region and the above-described part of the fifth region restrict movement of the fourth metallic part and the fifth metallic part in the direction in which they are separated from each other.

Thus, since the fourth metallic part and the fifth metallic part can be coupled by mechanically coupling the fourth region and the fifth region, it is possible to ensure the strength of the joint member of the fourth metal and the fifth metal.

(16) In some embodiments, in the above method (15), in the fourth layers, a plurality of layers are laminated, which are a group of linear beads formed by melting and solidifying the powder of the fourth metal, and the step of forming the coupling part includes decreasing a thickness of each of the beads or reducing a width of each of the beads in forming of a layer close to an interface with the fifth region as compared with forming of a layer far away from the interface, in the forming of the fourth region positioned above the part of the fifth region.

For example, in an alloy of a Fe—Ti system, a solid solution is not formed even if one metal of Fe or Ti is mixed into the other metal. Moreover, for example, in the alloy of the Fe—Ti system, even if one metal of Fe or Ti is mixed into the other metal, a melting point is lowered as an additive amount of the other metal increases. Thus, in the mixed layer of Fe and Ti, an intermetallic compound of Fe and Ti is generated in the entire of the mixed layer by mixing Fe and Ti, increasing hardness and making the layer fragile.

However, if a plurality of layers composed of the above-described one metal is further laminated on the mixed layer, a layer away from the mixed layer has a lower content of the above-described other metal than a layer close to the mixed layer. Thus, if the plurality of layers composed of the above-described one metal is further laminated on the mixed layer, the layer close to the mixed layer is increased in hardness and becomes fragile, whereas the layer away from the mixed layer is decreased in increasing rate of hardness.

In this regard, with the above method (16), the thickness of each of the beads is decreased or the width of each of the beads is reduced in the forming of the layer close to the interface with the fifth region as compared with the forming of the layer far away from the interface, in the forming of the fourth region positioned above the part of the fifth region. Therefore, even if the fourth layer of the fourth region close to the interface with the fifth region becomes fragile as described above, it is possible to suppress expansion of an area to be fragile, making it possible to suppress the decrease in strength of the joint member of the fourth metal and the fifth metal.

(17) In some embodiments, in the above method (15) or (16), the step of forming the coupling part includes forming at least a part of the fourth region such that a plurality of fourth lower beams and a plurality of fourth upper beams are arranged, the fourth lower beams extending in a direction crossing a lamination direction of the fourth layers, the fourth upper beams extending in a direction orthogonal to the lamination direction of the fourth layers and crossing an extending direction of the fourth lower beams, and being formed on top of the fourth lower beams, forming at least a part of the fifth region such that a plurality of fifth lower beams and a plurality of fifth upper beams are arranged, the fifth lower beams extending in a direction crossing a lamination direction of the fifth layers, the fifth upper beams extending in a direction crossing the lamination direction of the fifth layers and crossing an extending direction of the fifth lower beams, and being formed on top of the fifth lower beams, and extending one of the fourth lower beams and one of the fifth lower beams in a same direction, and extending one of the fourth upper beams and one of the fifth upper beams in a same direction.

With the above method (17), it is possible to mechanically couple the fourth region and the fifth region to each other directly or indirectly by the fourth region and the fifth region formed by the crossing beams, in the coupling part. Accordingly, it is possible to ensure a strength of a joint member of the fourth metallic part and the fifth metallic part, and to mitigate a thermal stress which is caused by a difference in linear expansion coefficient between the fourth metal and the fifth metal.

(18) In some embodiments, in the above method (17), the fourth lower beams and the fifth lower beams are formed such that the other fourth lower beams and the other fifth lower beams are alternately arranged along a direction crossing an extending direction of one of the fourth lower beams and one of the fifth lower beams, and the fourth upper beams and the fifth upper beams are formed such that the other fourth upper beams and the other fifth upper beams are alternately arranged along a direction crossing an extending direction of one of the fourth upper beams and one of the fifth upper beams.

With the above method (18), it is possible to mechanically couple the fourth region and the fifth region to each other directly by the fourth region and the fifth region formed by the crossing beams, in the coupling part. Accordingly, it is possible to ensure the strength of the joint member of the fourth metallic part and the fifth metallic part, and to mitigate the thermal stress which is caused by the difference in linear expansion coefficient between the fourth metal and the fifth metal.

(19) In some embodiments, in the above method (17) or (18), the step of forming the coupling part includes forming the fourth region such that at least two pairs of the fourth upper beams and the fourth lower beams are included from the fourth metallic part toward the fifth metallic part.

With the above method (19), it is possible to increase the number of stages of coupling between the fourth region and the fifth region, as compared with a case in which there is only one pair of the fourth upper beam and the fourth lower beam. Thus, the thermal stress caused by the difference in linear expansion coefficient between the fourth metal and the fifth metal is mitigated easily.

(20) In some embodiments, in the above method (19), the step of forming the coupling part includes forming the coupling part such that a proportion of the fourth region in a cross-section extending in the direction crossing the lamination direction of the fourth layers in the coupling part decreases from the fourth metallic part toward the fifth metallic part.

With the above method (20), since the coupling part is formed such that the proportion of the fourth region in the cross-section extending in the direction crossing the lamination direction of the fourth layers in the coupling part decreases from the fourth metallic part toward the fifth metallic part, it is possible to mitigate the thermal stress caused by the difference in linear expansion coefficient between the fourth metal and the fifth metal more effectively.

(21) An additive manufacturing method of a joint object according to at least one embodiment of the present invention includes a step of inserting, into a through hole of a sixth metallic part composed of a sixth metal, a columnar projecting portion of a seventh metallic part composed of a seventh metal of a different type from the sixth metal, and a step of forming a layer by melting and solidifying powder of the sixth metal at a tip of the projecting portion inserted into the through hole and at least a part of a region around the through hole of a surface of the seventh metallic part.

With the above method (21), since the layer is formed by melting and solidifying the powder of the sixth metal at the tip of the projecting portion inserted into the through hole and at least the part of the region around the through hole of the surface of the seventh metallic part, it is possible to assemble and couple the sixth metallic part and the seventh metallic part created separately from each other.

(22) An additive manufacturing method of a joint object according to at least one embodiment of the present invention includes a step of forming a layer on an eighth member composed of an eighth metal, by melting and solidifying powder of a ninth metal of a different type from the eighth metal. The eighth member includes a base portion, a first shaft-like portion which has a base end connected to the base portion and projects from the base portion, and a second shaft-like portion connected to a tip of the first shaft-like portion and having a larger diameter than the first shaft-like portion. The step of forming the layer includes forming a layer by melting and solidifying the powder of the ninth metal on respective circumferences of the first shaft-like portion and the second shaft-like portion, while rotating the eighth member about an axis of the first shaft-like portion.

With the above method (22), it is possible to form the layer by melting and solidifying the power of the ninth metal on the respective circumferences of the first shaft-like portion and the second shaft-like portion, even if the diameter of the base portion connected to the base end of the first shaft-like portion is larger than the diameter of the first shaft-like portion, and the second shaft-like portion having the larger diameter than the first shaft-like portion is formed at the tip of the first shaft-like portion.

(23) A joint member according to at least one embodiment of the present invention includes a fourth metallic part composed of a fourth metal, a fifth metallic part formed on the fourth metallic part and composed of a fifth metal of a different type from the fourth metal, and a coupling part including a fourth region and a fifth region, for coupling the fourth metallic part and the fifth metallic part by the fourth region and the fifth region, the fourth region being formed by the fourth metal and connected to the fourth metallic part, the fifth region formed by the fifth metal and connected to the fifth metallic part. In the coupling part, a part of the fourth region is positioned above a part of the fifth region.

With the above configuration (23), since the part of the fourth region is positioned above the part of the fifth region in the coupling part, the stress acts on the fourth region and the fifth region such that the above-described part of the fourth region and the above-described part of the fifth region are pressed toward each other, even if the pulling force acts in the direction in which the fourth metallic part and the fifth metallic part are separated from each other, in the joint member where the fifth metallic part is formed on the fourth metallic part. Therefore, the above-described part of the fourth region and the above-described part of the fifth region restrict movement of the fourth metallic part and the fifth metallic part in the direction in which they are separated from each other.

Thus, since the fourth metallic part and the fifth metallic part can be coupled by mechanically coupling the fourth region and the fifth region, it is possible to ensure the strength of the joint member.

### Advantageous Effects

According to at least one embodiment of the present invention, it is possible to suppress a decrease in strength of a joint member where metallic materials of different types are joined.

### BRIEF DESCRIPTION OF DRAWINGS

FIG. 1 is a schematic view showing the configuration of a three-dimensional additive manufacturing device to which an additive manufacturing method is applicable according to some embodiments.

FIG. 2 are diagrams showing some examples of binary phase diagrams, respectively.

FIG. 3A is a schematic view for describing that a melting point is raised as a mixture amount of Ti relative to Al increases.

FIG. 3B is a schematic view for describing that the melting point is raised as the mixture amount of Ti relative to Al increases.

FIG. 3C is a schematic view for describing that the melting point is raised as the mixture amount of Ti relative to Al increases.

FIG. 4A is a schematic view for describing that the melting point is lowered as a mixture amount of Ni relative to Ti increases.

FIG. 4B is a schematic view for describing that the melting point is lowered as the mixture amount of Ni relative to Ti increases.

FIG. 4C is a schematic view for describing that the melting point is lowered as the mixture amount of Ni relative to Ti increases.

FIG. 4D is a schematic view for describing that the melting point is lowered as the mixture amount of Ni relative to Ti increases.

FIG. 5 is a flowchart showing a processing procedure in the additive manufacturing method according to some embodiments.

FIG. 6 is an example of a graph where hardness of a member is measured which is formed by laminating, on the upper surface of a first metallic part composed of Fe serving as a first metal, a plurality of second layers composed of Ti serving as a second metal.

FIG. 7A is a schematic view showing an example of a coupling part.

FIG. 7B is a view showing a cross-section taken along line b-b of FIG. 7A.

FIG. 8A is a schematic cross-sectional view for describing a formation procedure of a region surrounded by a dashed line in FIG. 7B.

FIG. 8B is a schematic cross-sectional view for describing the formation procedure of the region surrounded by the dashed line in FIG. 7B.

FIG. 8C is a schematic cross-sectional view for describing the formation procedure of the region surrounded by the dashed line in FIG. 7B.

FIG. 8D is a schematic cross-sectional view for describing the formation procedure of the region surrounded by the dashed line in FIG. 7B.

FIG. 9A is a schematic cross-sectional view for describing a formation procedure of a coupling region positioned above the upper surface of an enlarged diameter portion.

FIG. 9B is a schematic cross-sectional view for describing the formation procedure of the coupling region positioned above the upper surface of the enlarged diameter portion.

FIG. 9C is a schematic cross-sectional view for describing the formation procedure of the coupling region positioned above the upper surface of the enlarged diameter portion.

FIG. 9D is a schematic cross-sectional view for describing the formation procedure of the coupling region positioned above the upper surface of the enlarged diameter portion.

FIG. 10 is a view showing an example of another embodiment of the coupling parts.

FIG. 11 is a view showing an example of another embodiment of the coupling parts.

FIG. 12A is a view showing an example of another embodiment of the coupling part.

FIG. 12B is a cross-sectional view of a three-dimensional additive manufactured object shown in FIG. 12A.

FIG. 13 shows views for each describing an example of a cross-sectional shape of the three-dimensional additive manufactured object according to some embodiments.

FIG. 14 shows views for, respectively, describing other embodiments of the three-dimensional additive manufactured objects according to some embodiments.

FIG. 15 shows views of an example of still another embodiment of the coupling part.

FIG. 16 shows views of an example of yet another embodiment of the coupling part.

FIG. 17 shows views each in which a coupling region in the three-dimensional additive manufactured object shown in FIG. 16 is simplistically drawn in order to describe a formation method of the coupling region.

FIG. 18 shows views of an example in a case in which an insert member as shown in FIG. 14 is applied to the three-dimensional additive manufactured object shown in FIG. 16.

FIG. 19 is a view showing another example in the case in which the insert member as shown in FIG. 14 is applied to the three-dimensional additive manufactured object shown in FIG. 16.

FIG. 20 shows schematic views for describing an example of a method of forming one joint object by coupling two members produced separately, by additive manufacturing.

FIG. 21 shows schematic views for describing another example of the method of forming one joint object by coupling two members produced separately, by additive manufacturing.

FIG. 22 shows schematic views for describing an example of a method of forming a portion with respect to a member produced in advance, by additive manufacturing.

### DETAILED DESCRIPTION

Some embodiments of the present invention will be described below with reference to the accompanying drawings. It is intended, however, that unless particularly identified, dimensions, materials, shapes, relative positions and the like of components described in the embodiments or shown in the drawings shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

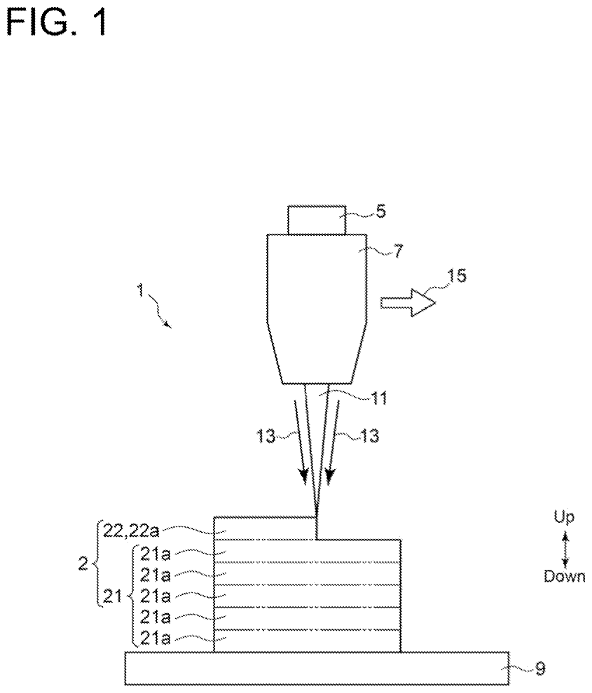

FIG. 1 is a schematic view showing the configuration of a three-dimensional additive manufacturing device 1 to which an additive manufacturing method is applicable according to some embodiments.

The three-dimensional additive manufacturing device 1 of an embodiment is a molding device by an LMD (Laser Metal Deposition) method, and is a device for molding a three-dimensional additive manufactured object 2 by irradiating metallic powder or the like, which is a material for a three-dimensional additive manufactured object, with an energy beam such as a laser beam to melt the metallic powder, spraying, solidifying, and laminating the melted metallic powder. The three-dimensional additive manufacturing device 1 of an embodiment includes a light source 5, a nozzle 7, and a molding stand 9.

The light source 5 generates an energy beam 11 such as a laser beam. The energy beam 11 from the light source 5 is emitted toward the molding stand 9. The nozzle 7 supplies metallic powder 13, which is a basic ingredient of the three-dimensional additive manufactured object 2, from the tip of the nozzle 7 onto the molding stand 9. The metallic powder 13, which is supplied from the tip of the nozzle 7 scanned as indicated by an arrow 15, is supplied onto the molding stand 9 in a state heated and melted by the energy beam 11. The three-dimensional additive manufacturing device 1 of an embodiment can thus form, on the molding stand 9, linear beads extending along a scanning direction of the nozzle 7. The three-dimensional additive manufacturing device 1 of an embodiment can form a sheet metallic layer by repeatedly scanning the nozzle 7. That is, the metallic layer formed by the three-dimensional additive manufacturing device 1 of an embodiment is a group of linear beads. The three-dimensional additive manufacturing device 1 of an embodiment can mold the three-dimensional additive manufactured object 2 by laminating a plurality of metallic layers.

Moreover, although not illustrated herein, the three-dimensional additive manufacturing device 1 of an embodiment can change the type of metallic powder 13 supplied from the nozzle 7. That is, the three-dimensional additive manufacturing device 1 of an embodiment includes at least two supply systems (not shown) for the metallic powder 13. The three-dimensional additive manufacturing device 1 of an embodiment can mold the three-dimensional additive manufactured object 2 made from the metallic powder 13 of at least two types, by appropriately switching the above-described supply systems. More specifically, the three-dimensional additive manufacturing device 1 of an embodiment can mold, by using, as basic ingredients, metallic powder of a certain type of metal (referred to as, for example, a first metal) and metallic powder of a second metal of a different type from the first metal, the three-dimensional additive manufactured object 2 where a part composed of the first metal (may also be referred to as a first metallic part 21, hereinafter) and a part composed of the second metal (may also be referred to as a second metallic part 22, hereinafter) are unified. In the following description, a three-dimensional additive manufactured object where metallic materials of different types are joined, such as the three-dimensional additive manufactured object 2 may also be referred to as a joint material.

In FIG. 1, regarding metallic layers formed by melting and solidifying, each boundary between adjacent layers is indicated by a corresponding one of long dashed double-dotted lines, for the descriptive convenience. In reality, however, such boundary may be invisible.

Further, FIG. 1 schematically shows a state in which the first metallic part 21 is formed by laminating a plurality of first layers 21a formed by the first metal. Furthermore, FIG. 1 schematically shows a state in the middle of forming the first layer of a second layer 22a formed by the second metal on the upper surface of the first metallic part 21.

In the three-dimensional additive manufactured object 2 where the first metallic part and the second metallic part are joined, mixture of the first metal and the second metal occurs in the vicinity of a joint interface between the first metal and the second metal. More specifically, for example, in a case in which the layer of the second metal is formed on the first metallic part that has already been formed, if the melted second metal adheres to the surface of the first metallic part, a part of the surface of the first metallic part is melted and mixed into the melted second metal.

At this time, depending on types of metals, a fragile area by an intermetallic compound of the first metal and the second metal is generated by mixing the first metal into the melted second metal. If the fragile area is generated at the joint interface of the metallic materials of the different types, a joint strength at the joint interface is decreased, decreasing a strength of the joint member.

However, if the combination of the first metal and the second metal is, for example, a combination capable of forming a solid solution of the first metal and the second metal, it is possible to suppress formation of the fragile area by the intermetallic compound by generating not the intermetallic compound but the solid solution of the first metal and the second metal.

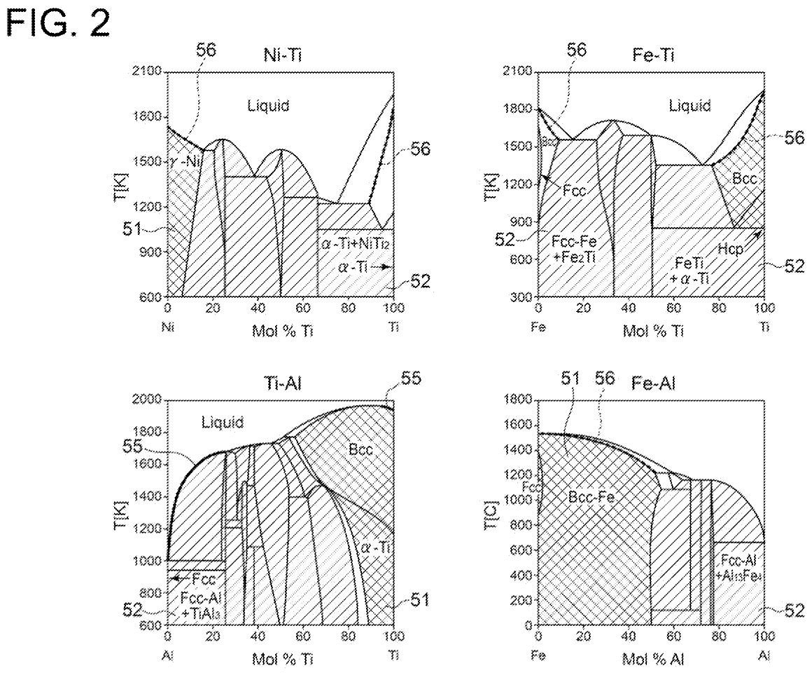

FIG. 2 are diagrams showing some examples of binary phase diagrams, respectively. FIG. 2 illustrates, for example, a Ni—Ti phase diagram, a Fe—Ti phase diagram, a Ti—Al phase diagram, and a Fe—Al phase diagram. In each of the phase diagrams, a region 51 indicates a region where only the solid solution is obtained, and a region 52 indicates a region where the intermetallic compound and the solid solution or only the intermetallic compound is obtained.

As can be seen in FIG. 2, in an Ni—Ti system, the solid solution is obtained in a case in which Ni is a main component metal and Ti is an added metal. Therefore, forming a Ni layer on the surface of an already formed portion composed of Ti, Ti is mixed into melted Ni from the portion composed of Ti, thereby it is possible to form the solid solution by Ni and Ti in the vicinity of an interface between Ni and Ti. Thus, it is possible to suppress formation of the fragile area by the intermetallic compound, making it possible to suppress a decrease in strength of a joint member of Ni and Ti.

Likewise, it can be seen that, in a Ti—Al system, the solid solution is obtained in a case in which Ti is a main component metal and Al is an additive metal, and in a Fe—Al system, the solid solution is obtained in a case in which Fe is a main component metal and Al is an additive metal. Therefore, forming a Ti layer on the surface of an already formed portion composed of Al, it is possible to form the solid solution by Ti and Al in the vicinity of an interface between

Ti and Al. Moreover, forming a Fe layer on the surface of the already formed portion composed of Al, it is possible to form the solid solution by Fe and Al in the vicinity of an interface between Fe and Al.

As can be seen in FIG. 2, in a Fe—Ti system, the solid solution cannot be obtained, in both of a case in which Fe is a main component metal and Ti is an added metal, and a case in which Ti is a main component metal and Fe is an added metal.

In FIG. 2, as indicated by a phase boundary 55 represented by a bold solid line, if another metal serving as an added metal is mixed into a main component metal, a melting point may be raised as a mixture amount increases. Moreover, in FIG. 2, as indicated by a phase boundary 56 represented by a bold dashed line, if another metal serving as an added metal is mixed into a main component metal, a melting point may be lowered as a mixture amount increases. In the Fe—Al phase diagram, in a case in which Al is a main component metal and Fe is an added metal, a region exists where a melting point is lowered as a mixture amount of Fe increases. However, the above-described region is small, and is thus not shown in FIG. 2.

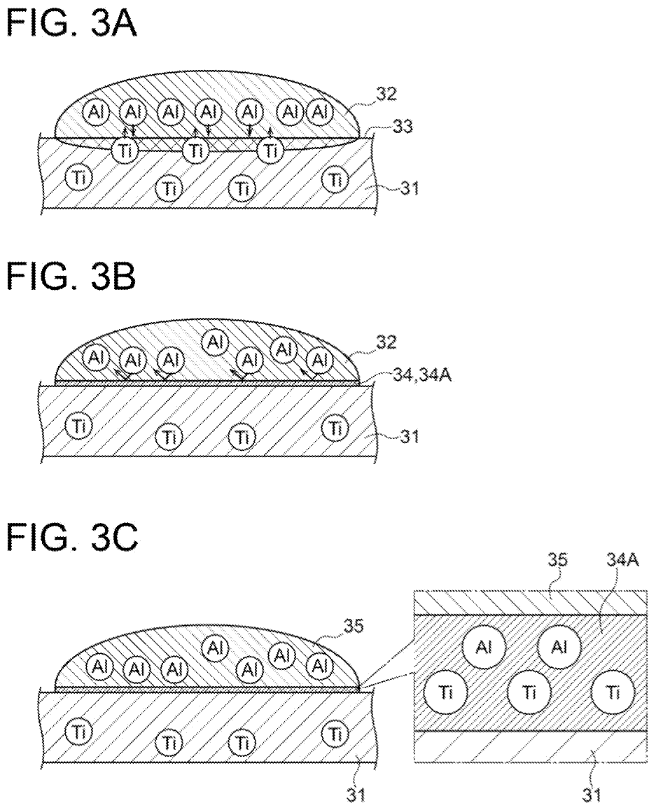

For example, as in the Ti—Al system, a case in which if Ti is mixed into Al serving as the main component metal, the melting point is raised as the mixture amount increases will be described with reference to FIGS. 3A to 3C. FIGS. 3A to 3C are schematic views for describing that the melting point is raised as the mixture amount of Ti relative to Al increases.

As shown in FIG. 3A, if melted Al 32 adheres to an already formed portion 31 composed of Ti, the surface of the portion 31 composed of Ti is melted, and Ti and Al are mixed in the vicinity of an interface 33 between the portion 31 composed of Ti and the melted Al 32.

If Ti and Al are mixed in the vicinity of the interface 33, a melting point of the mixed portion is raised relative to a melting point of the Al 32, solidifying a mixed portion 34 as shown in FIG. 3B. Consequently, a layer (mixed layer) 34A obtained by solidifying the mixed portion 34 of Ti and Al is formed between the portion 31 composed of Ti and the melted Al 32. Accordingly, the mixed layer 34A prevents progression of mixture of the melted Al 32 and Ti from the portion 31 composed of Ti.

Subsequently, as shown in FIG. 3C, the melted Al 32 is solidified, forming an Al layer 35.

In the case of the Ti—Al system, in the mixed layer 34A containing Al as the main component metal, an intermetallic compound of Al and Ti is generated by mixture of Ti. However, the thickness of the mixed layer 34A is smaller than the thickness of the Al layer 35, and thus the thickness of a fragile area is smaller than the thickness of the Al layer 35. Thus, it is possible to reduce an influence on the strength of the joint member of Ti and Al.

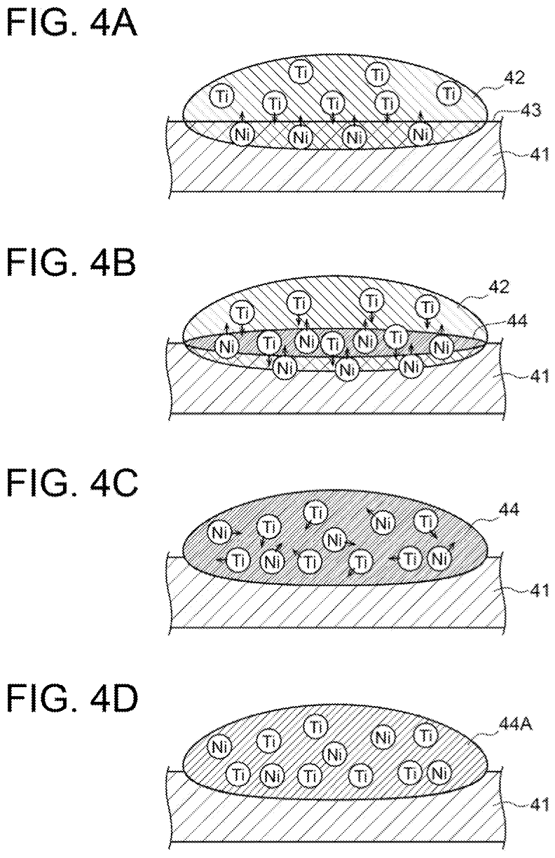

Contrary to the case of the Ti—Al system described above, as in the Ni—Ti system, a case in which if Ti serving as the main component metal is mixed into Ni, the melting point is lowered as the mixture amount increases will be described with reference to FIGS. 4A to 4D. FIGS. 4A to 4D are schematic views for describing that the melting point is raised as the mixture amount of Ni relative to Ti increases.

As shown in FIG. 4A, if melted Ti 42 adheres to an already formed portion 41 composed of Ni, the surface of the portion 41 composed of Ni is melted, and Ni and Ti are mixed in the vicinity of an interface 43 between the portion 41 composed of Ni and the melted Ti 42.

As shown in FIG. 4B, if Ni and Ti are mixed in the vicinity of the interface 43, a melting point of a mixed portion 44 is lowered relative to a melting point of the Ti 42. Accordingly, a melted state of the mixed portion 44 is maintained, progressing mixture of the melted Ti 42 and Ni from the portion 41 composed of Ni. If the mixture amount of Ni relative to the melted Ti 42 increases due to the progress of the mixture, the melting point of the mixed portion 44 is further lowered. Thus, the melted state of the mixed portion 44 is maintained, further progressing the mixture of the melted Ti 42 and Ni from the portion 41 composed of Ni. Thus, as shown in FIG. 4C, the mixed portion 44 is obtained in which Ni is mixed over the entire of a melted region. Subsequently, as shown in FIG. 4D, the mixed portion 44 is solidified, forming a mixed layer 44A.

In the case of the Ni—Ti system, in the mixed layer 44A containing Ti as a main component, an intermetallic compound of Ti and Ni is generated by mixture of Ni.

In view of the foregoing, in the case in which the layer of the second metal is formed on the first metallic part that has already been formed, in order to suppress the decrease in strength of the joint member, the combination of the first metal and the second metal preferably satisfies at least one of the following condition (a) or (b):

(a) if the first metal serving as an added metal is added to the second metal serving as a main component metal, a combination capable of forming a solid solution; or
(b) if the first metal serving as the added metal is added to the second metal serving as the main component metal, a combination raising a melting point as an additive amount of the first metal increases.

Thus, in the additive manufacturing method according to some embodiments, at least one of the above condition (a) or (b) is satisfied.

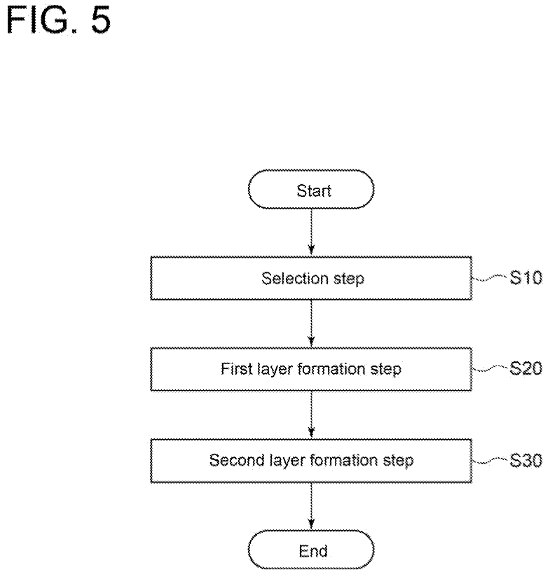

FIG. 5 is a flowchart showing a processing procedure in the additive manufacturing method according to some embodiments.

The additive manufacturing method according to some embodiments includes a selection step S10, a first layer formation step S20, and a second layer formation step S30.

The selection step S10 is a step of selecting the first metal and the second metal which are the combination capable of forming the solid solution as in the above condition (a) or the combination raising the melting point as in the above condition (b).

More specifically, in the selection step S10, for example, based on the phase diagrams as shown in FIG. 2, the combination of the metal materials satisfying at least one of the above condition (a) or (b) is selected to decide a metal (first metal) by which a part is formed first and a metal (second metal) by which a layer is formed later. Note that the types of metals to be the first metal and the second metal, respectively, may manually be determined and decided based on the phase diagrams. Alternatively, the types of metals to be the first metal and the second metal, respectively, may be decided by a CPU of a computer (not shown) by storing information regarding a combination of metals that satisfies at least one of the above condition (a) or (b), information regarding the phase diagrams as shown in FIG. 2, and the like in, for example, a storage part of the computer.

The first layer formation step S20 is a step of forming the first layers 21a by melting and solidifying powder of the first metal with the three-dimensional additive manufacturing device 1 of an embodiment.

The first layer formation step S20 includes forming the first metallic part 21 (see FIG. 1) composed of the first metal by laminating the plurality of first layers 21a composed of the first metal.

The second layer formation step S30 is a step of forming the second layers 22a on the first layers 21a (first metallic part 21) by melting and solidifying powder of the second metal with the three-dimensional additive manufacturing device 1 of an embodiment.

The second layer formation step S30 includes forming the second metallic part 22 (see FIG. 1) composed of the second metal on the first metallic part 21 by laminating the plurality of second layers 22a composed of the second metal.

Thus, the additive manufacturing method according to some embodiments includes the first layer formation step S20 and the second layer formation step S30. Then, in the additive manufacturing method according to some embodiments, the first metal and the second metal are the combination satisfying at least one of the above condition (a) or (b).

As long as the first metal and the second metal are the combination capable of forming the solid solution as described above, it is possible to generate not the intermetallic compound but the solid solution of the first metal and the second metal, even if the first metal is mixed into the melted second metal in formation of the second layer 22a. Thus, it is possible to suppress formation of the fragile area by the intermetallic compound, making it possible to suppress a decrease in strength of the three-dimensional additive manufactured object 2 which is a joint member of the first metal and the second metal.

Moreover, as long as the first metal and the second metal are the combination raising the melting point as described above, a melting point in a mixed portion 24 (see FIG. 3B) of the first metal and the second metal increases relative to a melting point of the second metal, solidifying the mixed portion 24, if the first metal is mixed into the melted second metal in formation of the second layer 22a. Consequently, the layer (mixed layer 24A) obtained by solidifying the mixed portion 24 of the first metal and the second metal is formed between the first layer 21a and the melted second metal. Thus, since the mixed layer 24A suppresses mixture of the first metal from the first layer 21a to the melted second metal, it is possible to suppress formation of the fragile area by the intermetallic compound, and to suppress the decrease in strength of the three-dimensional additive manufactured object 2 which is the joint member of the first metal and the second metal.

Moreover, the additive manufacturing method according to some embodiments further includes the selection step S10.

Thus, since the first metal and the second metal are the combination capable of forming the solid solution as described above or the combination raising the melting point as described above, it is possible to suppress formation of the fragile area by the intermetallic compound in the vicinity of the interface between the first layer and the second layer, and to suppress the decrease in strength of the three-dimensional additive manufactured object 2 which is the joint member of the first metal and the second metal.

In the second layer formation step S30, the second layer 22a is formed on a processing condition in which a content of the first metal in the second layer 22a is not more than a limit capable of forming the solid solution as described above.

More specifically, the processing condition can appropriately be changed by adjusting an output of the energy beam 11, a pulse duty of the energy beam 11, a scanning speed of the nozzle 7, a supply rate of the metallic powder 13, or the like. The pulse duty of the energy beam 11 is a parameter representing the ratio of an irradiation time of the energy beam 11 per unit time.

Thus, it is possible to generate not the intermetallic compound but the solid solution of the first metal and the second metal, even if the first metal is mixed into the melted second metal. Thus, it is possible to suppress formation of the fragile area by the intermetallic compound, making it possible to suppress the decrease in strength of the three-dimensional additive manufactured object 2 which is the joint member of the first metal and the second metal.

As the Fe—Ti system, in the case in which neither the above condition (a) nor (b) is satisfied, Fe and Ti are mixed over the entire of the melted region of the second metal, and then the mixed portion 44 is solidified, forming the mixed layer 44A of Fe and Ti (see FIG. 4C, 4D). In the mixed layer 44A of Fe and Ti, Fe and Ti are mixed, generating an intermetallic compound of Fe and Ti in the entire of the mixed layer 44A.

If the second layer 22a composed of the second metal is further laminated on the mixed layer 44A, the second layer 22a newly laminated on the already laminated second layer 22a has a lower content of the first metal than the already laminated second layer 22a. That is, the content of the first metal is decreased in the second layer 22a away from the mixed layer 44A, as compared with the second layer 22a close to the mixed layer 44A. This is because the first metal to be mixed into the newly formed second layer 22a is derived from the first metal contained in the second layer 22a that has already been formed under the newly formed second layer 22a.

Thus, if the second layer 22a composed of the second metal is further laminated on the mixed layer 44A, the second layer 22a close to the mixed layer 44A is increased in hardness and becomes fragile, whereas the second layer 22a away from the mixed layer 44A is decreased in increasing rate of hardness.

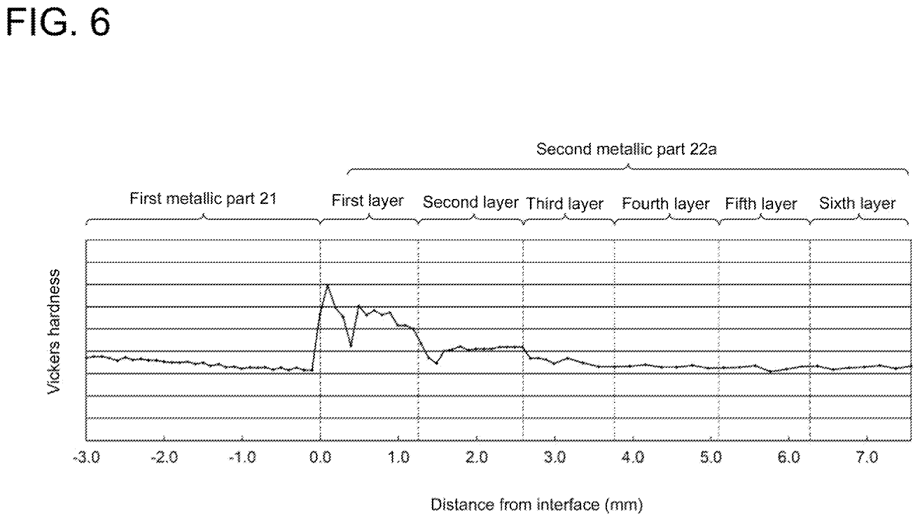

FIG. 6 is an example of a graph where hardness of a member is measured which is formed by laminating, on the upper surface of the first metallic part 21 composed of Fe serving as the first metal, the plurality of second layers 22a composed of Ti serving as the second metal. As shown in FIG. 6, hardness is high in the first layer of the second layers 22a but from the fourth layer, hardness is the same as hardness on the side of the first metallic part 21.

Thus, in the additive manufacturing method according to some embodiments, if neither the above condition (a) nor (b) is satisfied, in the second layer formation step S30, the second layers 22a are laminated while reducing at least one of the height or the width of each of the beads forming the second layers 22a to the predetermined number of laminations in which an influence by mixture of the first metal in the second layers 22a can substantially be ignored.

In order to reduce at least one of the height or the width of the bead, it is only necessary to appropriately adjust the output of the energy beam 11, the pulse duty of the energy beam 11, the scanning speed of the nozzle 7, the supply rate of the metallic powder 13, or the like.

The height of the bead is the size of the bead along the lamination direction of the second layers 22a, and the width of the bead is the size of the bead along a direction orthogonal to the scanning direction of the nozzle 7 and the lamination direction of the second layers 22a.

As will be described later, after a coupling strength between the first metallic part 21 and the second metallic part 22 is ensured by forming a coupling part for mechanically coupling the first metallic part 21 and the second metallic part 22, the second layers 22a may be laminated while reducing at least one of the height or the width of each of the beads forming the second layers 22a to the predetermined number of laminations as described above.

Thus, even if neither the above condition (a) nor (b) is satisfied, it is possible to suppress expansion of an area to be fragile due to the increase in hardness, making it possible to suppress the decrease in strength of the three-dimensional additive manufactured object 2 which is the joint member of the first metal and the second metal.

(Coupling Part)

In the additive manufacturing method according to some embodiments described above, the joint strength (coupling strength) between the first metallic part 21 and the second metallic part 22 depends on the joint strength at the interface between the first metallic part 21 and the second metallic part 22. However, it is considered that the coupling strength between the first metallic part 21 and the second metallic part 22 is ensured by mechanically coupling the first metallic part 21 and the second metallic part 22.

Thus, in the additive manufacturing method according to some embodiments to be described below, the coupling strength between the first metallic part 21 and the second metallic part 22 is ensured by forming the coupling part for mechanically coupling the first metallic part 21 and the second metallic part 22.

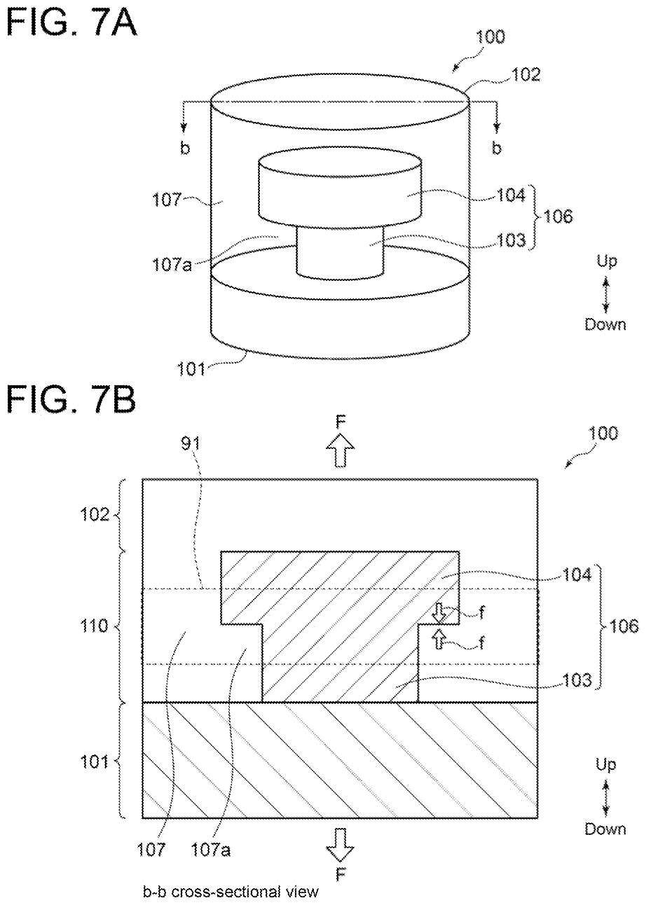

FIG. 7A is a schematic view showing an example of the coupling part. FIG. 7B is a view showing a cross-section taken along line b-b of FIG. 7A. For the descriptive convenience, in the following description, a lower part in the figure will be referred to as a lower metallic part 101, and an upper part in the figure will be referred to as an upper metallic part 102. A three-dimensional additive manufactured object 100 shown in FIG. 7A includes the lower metallic part 101 composed of a metal A and the upper metallic part 102 composed of a metal B which is different from the metal A. The up-down direction in FIG. 7A is the same direction as the up-down direction at the time of additive manufacturing of the three-dimensional additive manufactured object 100. That is, the three-dimensional additive manufactured object 100 shown in FIG. 7A is formed by laminating metallic layers sequentially from below in the figure.

The three-dimensional additive manufactured object 100 shown in FIG. 7A includes a reduced diameter portion 103 protruding upward from the upper surface of the lower metallic part 101, and an enlarged diameter portion 104 formed on top of the reduced diameter portion 103. In the three-dimensional additive manufactured object 100 shown in FIG. 7A, the reduced diameter portion 103 and the enlarged diameter portion 104 each have a columnar shape. Thus, a direction orthogonal to the up-down direction in the reduced diameter portion 103 and the enlarged diameter portion 104 will be referred to as a radial direction. Note that for the descriptive convenience, the direction orthogonal to the up-down direction may also be referred to as the radial direction in each of the views from FIG. 7A. For example, regarding a portion which has neither a columnar shape nor a cylindrical shape in each of the views from FIG. 7A, a direction orthogonal to the up-down direction in the concerned portion may also be referred to as the radial direction, and the dimension in the radial direction may be referred to as a diameter, an outer diameter, an inner diameter, and the like.

The reduced diameter portion 103 has an outer diameter which is smaller than an outer diameter of the lower metallic part 101. The enlarged diameter portion 104 has an outer diameter which is smaller than the outer diameter of the lower metallic part 101 and is larger than the reduced diameter portion 103.

The reduced diameter portion 103 and the enlarged diameter portion 104 constitute a coupling region 106 connected from the lower metallic part 101 and composed of the metal A.

The outer surfaces of the reduced diameter portion 103 and the enlarged diameter portion 104 are covered with a coupling region 107 connected from the upper metallic part 102 and composed of the metal B, and is joined with the metal B forming the coupling region 107.

For the descriptive convenience, the reduced diameter portion 103 and the enlarged diameter portion 104 each have the columnar shape. However, the reduced diameter portion 103 may have an elliptic columnar shape or a prismatic shape, and the enlarged diameter portion 104 may have an elliptic columnar shape or a prismatic shape. Moreover, the reduced diameter portion 103 and the enlarged diameter portion 104 may have pillar shapes with cross-sectional shapes different from each other, such as the reduced diameter portion 103 has the columnar shape and the enlarged diameter portion 104 has the prismatic shape.

That is, a state is obtained in which a partial region 107a of the coupling region 107 composed of the metal B enters below the enlarged diameter portion 104. Thus, in the three-dimensional additive manufactured object 100 shown in FIG. 7A, as a region surrounded by a dashed line 91 in FIG. 7B, the enlarged diameter portion 104 is fitted into the partial region 107a of the coupling region 107 entering below the enlarged diameter portion 104.

That is, in the three-dimensional additive manufactured object 100 shown in FIG. 7A, the coupling region 106 composed of the metal A and the coupling region 107 composed of the metal B form a coupling part 110 for mechanically coupling the lower metallic part 101 and the upper metallic part 102.

In order to obtain the three-dimensional additive manufactured object 100 including the above-described coupling part 110, the additive manufacturing method according to some embodiments preferably further includes a step of forming the coupling part 110.

That is, the step of forming the coupling part 110 is a step of forming the coupling part 110 which includes the coupling region 107 connected to the upper metallic part 102 and the coupling region 106 connected to the lower metallic part 101, for mechanically coupling the upper metallic part 102 and the lower metallic part 101 by the coupling region 107 connected to the upper metallic part 102 and the coupling region 106 connected to the lower metallic part 101.

Then, in the additive manufacturing method according to some embodiments, the step of forming the coupling part 110 includes forming the respective coupling regions 106, 107 such that a part of the coupling region 106 connected to the lower metallic part 101 is positioned above a part (the region 107a to be described later) of the coupling region 107 connected to the upper metallic part 102.

As shown in FIG. 7B, even if a pulling force F acts on the three-dimensional additive manufactured object 100 in a direction in which the lower metallic part 101 and the upper metallic part 102 are separated from each other, a stress acts on the coupling region 106 and the coupling region 107 such that the enlarged diameter portion 104 which is a part of the coupling region 106 and the region 107a which is a part of the coupling region 107 are pressed toward each other, as indicated by arrows f. Therefore, the enlarged diameter portion 104 which is a part of the coupling region 106 and the region 107a which is a part of the coupling region 107 restrict movement of the lower metallic part 101 and the upper metallic part 102 in the direction in which they are separated from each other.

Thus, since the lower metallic part 101 and the upper metallic part 102 can be coupled by mechanically coupling the coupling region 106 composed of the metal A and the coupling region 107 composed of the metal B, it is possible to improve not only the joint strength at the interface between the metal A and the metal B but also the strength of the three-dimensional additive manufactured object 100 which is the joint member of the lower metallic part 101 and the upper metallic part 102.

In the three-dimensional additive manufactured object 100 shown in FIGS. 7A and 7B, as the region surrounded by the dashed line 91 in FIG. 7B, a region exists in which the enlarged diameter portion 104 is fitted into the partial region 107a of the coupling region 107 entering below the enlarged diameter portion 104. As described above, if the pulling force F acts on the three-dimensional additive manufactured object 100 in the direction in which the lower metallic part 101 and the upper metallic part 102 are separated from each other, the stress acts on the coupling region 106 and the coupling region 107 such that the enlarged diameter portion 104 and the partial region 107a of the coupling region 107 are pressed toward each other, as indicated by the arrows f.

Thus, the region surrounded by the dashed line 91 in FIG. 7B largely influences the coupling strength between the lower metallic part 101 and the upper metallic part 102, as compared with other regions. Therefore, it is desirable that a strength of the region surrounded by the dashed line 91 can be ensured when the region surrounded by the dashed line 91 is formed.

However, as described above, depending on the types of metal A and metal B, the fragile area by the intermetallic compound of the metal A and the metal B is generated.

Thus, in the additive manufacturing method according to some embodiments, the types of metal A and metal B are selected such that, for example, an influence on the strength of the region surrounded by the dashed line 91 is small.

In the additive manufacturing method according to some embodiments, the three-dimensional additive manufactured object 100 is molded by sequentially laminating the metallic layers upward from below. For example, focusing on the region surrounded by the dashed line 91, in a section of the enlarged diameter portion 104 having a larger diameter than the reduced diameter portion 103, the enlarged diameter portion 104 composed of the metal A is formed on the coupling region 107 composed of the metal B. Thus, following the condition (a) and the condition (b) than have already been described regarding the combination of the first metal and the second metal, the combination of the metal A and the metal B desirably satisfies one of the following condition (a1) or (b1):

(a1) if the metal B serving as an added metal is added to the metal A serving as a main component metal, a combination capable of forming a solid solution; or
(b1) if the metal B serving as the added metal is added to the metal A serving as the main component metal, a combination raising a melting point as an additive amount of the metal B increases.

For example, in the case of the Ni—Ti system, setting the metal A as Ni and the metal B as Ti, it is possible to form a solid solution by Ni and Ti in the vicinity of an interface between the lower surface of the enlarged diameter portion 104 and the partial region 107a of the coupling region 107 in contact with the lower surface. In this case, the above condition (a1) is satisfied.

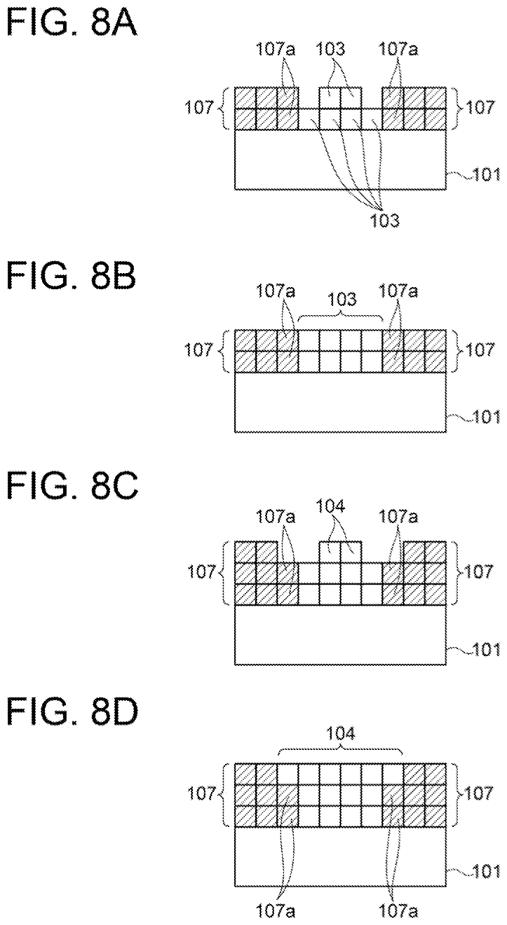

FIGS. 8A to 8D are schematic cross-sectional views for describing the formation procedure of the region surrounded by the dashed line 91 in FIG. 7B.

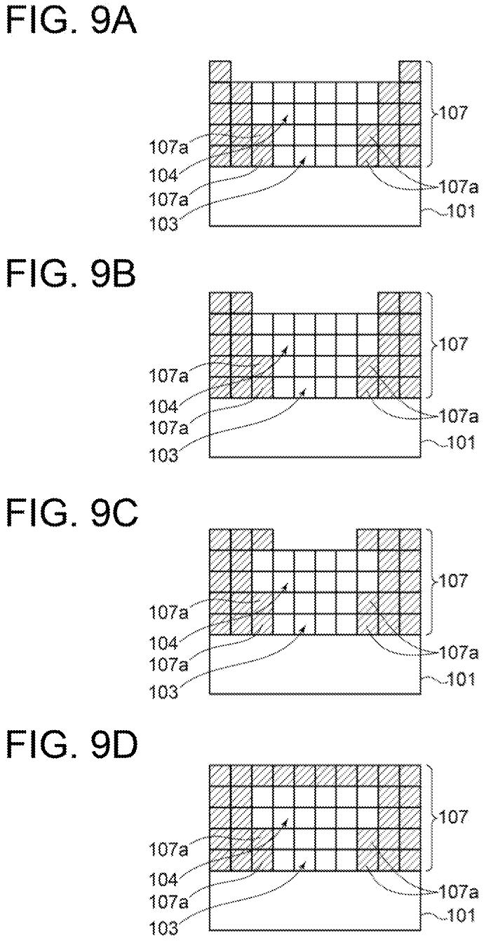

Small squares in FIGS. 8A to 8D and FIGS. 9A to 9D to be described later simulate the beads, respectively, and each of the squares represents the cross-section of the bead formed by one scanning of the nozzle 7. However, in a case in which the columnar shape or the cylindrical shape as shown in FIG. 7A is formed, each bead is formed into a circular shape. Thus, in each of the cross-sectional views of FIGS. 8A to 8D and FIGS. 9A to 9D to be described later, two squares at bilaterally symmetric positions with respect to a center line of the column or the cylinder may be formed by one scanning in which the nozzle 7 makes a single round along the circumferential direction.

In FIGS. 8A to 8D and FIGS. 9A to 9D, for the descriptive convenience, the size of each square is represented to be larger than the cross-section of the actual bead. For example, in FIG. 8D, the section of the enlarged diameter portion 104 having the larger diameter than the reduced diameter portion 103 is represented as if the section is formed by one scanning in which a single round is made along the circumferential direction. In reality, however, the section is formed by performing scanning a plurality of times.

In the additive manufacturing method according to some embodiments, first, as shown in FIG. 8A, before the reduced diameter portion 103 is formed, the partial region 107a of the coupling region 107 and the coupling region 107 at a position of the same height as the partial region 107a are formed. Subsequently, the reduced diameter portion 103 is formed. Thus, even if Ti derived from the region 107a is mixed into the beads of Ni constituting the reduced diameter portion 103, a solid solution by Ni and Ti is formed in the vicinity of an interface between the reduced diameter portion 103 and the region 107a. Thus, it is possible to suppress formation of the fragile area by the intermetallic compound, making it possible to suppress a decrease in strength of the three-dimensional additive manufactured object 100.

Moreover, in a case in which the metal A and the metal B satisfy the above-described condition (b1), a melting point in a mixed portion of the metal A and the metal B increases relative to a melting point of the metal A, solidifying the mixed portion, if the melted metal B derived from the region 107a is mixed into the melted metal A. Consequently, a layer (mixed layer) obtained by solidifying the mixed portion of the metal A and the metal B is formed between the region 107a and the melted metal A. Thus, since the mixed layer suppresses mixture of the metal B from the region 107a to the melted metal A, it is possible to suppress formation of the fragile area by the intermetallic compound, and to suppress the decrease in strength of the three-dimensional additive manufactured object 100.

In formation of the reduced diameter portion 103, as shown in FIG. 8A, the reduced diameter portion 103 is formed from a position first which is present on the radially outer side of the reduced diameter portion 103 and is away from the region 107a, and then as shown in FIG. 8B, the reduced diameter portion 103 is formed radially outward. Thus forming the reduced diameter portion 103 from the position away from the region 107a first in formation of the reduced diameter portion 103, it is possible to suppress expansion of a region into which Ti derived from the region 107a is mixed in the reduced diameter portion 103. That is, if the reduced diameter portion 103 (temporarily referred to as a first region of the reduced diameter portion) is formed from a position adjacent to the region 107a first, Ti that has mixed into the first region of the reduced diameter portion is further mixed into the reduced diameter portion 103 (temporarily referred to as a second region of the reduced diameter portion) which is formed, after the first region of the reduced diameter portion, adjacent to the first region of the reduced diameter portion. Therefore, forming the reduced diameter portion 103 from the position adjacent to the region 107a first, the region into which Ti derived from the region 107a is mixed expands.

Thus, in the additive manufacturing method according to some embodiments, expansion of the region into which Ti derived from the region 107a is mixed in the reduced diameter portion 103 is suppressed by forming the reduced diameter portion 103 from the position away from the region 107a first as described above.

In the additive manufacturing method according to some embodiments, first, as shown in FIG. 8C, before the enlarged diameter portion 104 is formed, the coupling region at a position of the same height as the enlarged diameter portion 104 is formed. Subsequently, the enlarged diameter portion 104 is formed. Thus, even if Ti derived from the coupling region 107 is mixed into the beads of Ni constituting the enlarged diameter portion 104, the solid solution by Ni and Ti is formed in the vicinity of an interface between the enlarged diameter portion 104 and the coupling region 107. In formation of the enlarged diameter portion 104, as shown in FIG. 8C, the enlarged diameter portion 104 is formed from a position first which is present on the radially outer side of the enlarged diameter portion 104 and is away from the coupling region 107, and then as shown in FIG. 8D, the enlarged diameter portion 104 is formed radially outward. Thus forming the enlarged diameter portion 104 from the position away from the coupling region 107 first, it is possible to suppress expansion of the region into which Ti derived from the coupling region 107 is mixed in the enlarged diameter portion 104.

FIGS. 9A to 9D are schematic cross-sectional views for describing a formation procedure of the coupling region 107 positioned above the upper surface of the enlarged diameter portion 104.

Small squares in FIGS. 9A to 9D simulate the beads, respectively, as in FIGS. 8A to 8D.

In the case in which the coupling region 107 positioned above the upper surface of the enlarged diameter portion 104 is formed, the coupling region 107 is formed from a position away from the enlarged diameter portion 104 first, as shown in FIGS. 9A and 9B, such that Ni derived from the enlarged diameter portion 104 is mixed into Ti composing the coupling region 107 as little as possible, that is, such that the coupling region 107 where Ni derived from the enlarged diameter portion 104 is mixed is narrowed. Moreover, a portion immediately above the enlarged diameter portion 104, which has a low contribution to the mechanical coupling strength between the lower metallic part 101 and the upper metallic part 102 in the coupling part 110, is formed after other portions. That is, even if the fragile area by the intermetallic compound is generated by mixture of Ni derived from the enlarged diameter portion 104 into Ti composing the coupling region 107, the region having the low contribution to the mechanical coupling strength between the lower metallic part 101 and the upper metallic part 102 in the coupling part 110 is formed late in the formation process of the coupling region 107.

(Another Embodiment of Coupling Part 110)

Another embodiment of the coupling part 110 will be described.

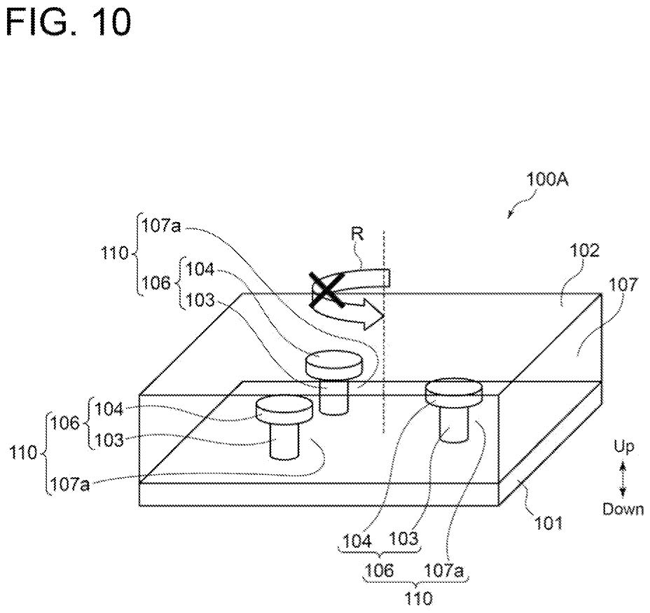

FIG. 10 is a view showing an example of another embodiment of the coupling parts 110.

For example, as shown in FIG. 10, in a three-dimensional additive manufactured object 100A, the coupling parts 110 may, respectively, be formed at a plurality of positions which are different positions as viewed from the up-down direction, that is, the lamination direction of the metallic layers.

In the step of forming the coupling part 110, for example, as shown in FIG. 7A, in the case in which the coupling part 110 having, for example, a circular shape as viewed from the lamination direction of the metallic layers is formed at only one spot, if the joint strength at the interface between the lower metallic part 101 and the upper metallic part 102 is not sufficient, the lower metallic part 101 and the upper metallic part 102 may rotate each other about the center axis of the rotor.

In this regard, as shown in FIG. 10, if the coupling parts 110 are, respectively, formed at the plurality of positions which are the different positions as viewed from the lamination direction of the metallic layers, as described above, it is possible to suppress the mutual rotation of the lower metallic part 101 and the upper metallic part 102 as indicated by an arrow R. Therefore, with the three-dimensional additive manufactured object 100A as shown in FIG. 10, it is possible to improve the strength of the three-dimensional additive manufactured object 100A.

Moreover, for example, as shown in FIG. 10, in the three-dimensional additive manufactured object 100A, the coupling parts 110 may, respectively, be formed at at least three spots which are positions not in the same straight line as viewed from the lamination direction of the metallic layers.

In the step of forming the coupling part 110, in the case in which the plurality of coupling parts 110 are formed so as to exist in the same straight line as viewed from the lamination direction of the metallic layers, if the joint strength at the interface between the lower metallic part 101 and the upper metallic part 102 is not sufficient, the strength of the three-dimensional additive manufactured object may be insufficient with respect to a bending stress acting along a surface orthogonal to the straight line.

In this regard, as shown in FIG. 10, if the coupling parts 110 are, respectively, formed at the at least three spots which are the positions not in the same straight line as viewed from the lamination direction of the metallic layers, it is possible to suppress the insufficient strength of the three-dimensional additive manufactured object 100A with respect to the above-described bending stress. Therefore, with the three-dimensional additive manufactured object 100A as shown in FIG. 10, it is possible to improve the strength of the three-dimensional additive manufactured object 100A.

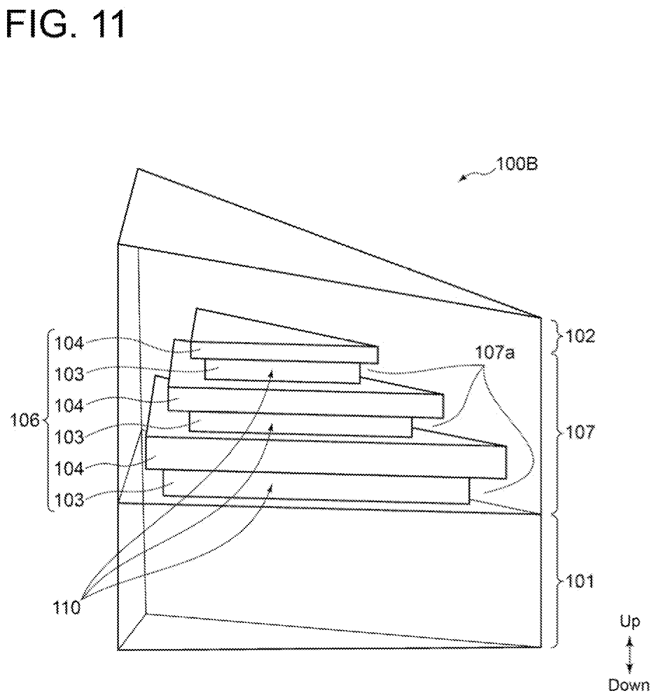

FIG. 11 is a view showing an example of another embodiment of the coupling parts 110.

For example, as shown in FIG. 11, in a three-dimensional additive manufactured object 100B, each of the coupling parts 110 may be formed into a polygonal shape or an oval shape as viewed from the up-down direction, that is, the lamination direction of the metallic layers.

In the step of forming the coupling part, for example, in the case in which the coupling part 110 is formed to be the rotor as in the case in which the coupling part 110 is formed into, for example, the circular shape as viewed from the lamination direction of the metallic layers as shown in FIG. 7A, if the joint strength at the interface between the lower metallic part 101 and the upper metallic part 102 is not sufficient, the lower metallic part 101 and the upper metallic part 102 may rotate each other about the center axis of the rotor.

In this regard, forming each coupling part 110 to have the polygonal shape or the oval shape as viewed from the lamination direction of the metallic layers as shown in FIG. 11, it is possible to suppress the mutual rotation of the lower metallic part 101 and the upper metallic part 102 as described above, even if the joint strength at the interface between the lower metallic part 101 and the upper metallic part 102 is not sufficient. Therefore, with the three-dimensional additive manufactured object 100B as shown in FIG. 11, it is possible to improve the strength of the three-dimensional additive manufactured object 100B.

Moreover, for example, as shown in FIG. 11, in the three-dimensional additive manufactured object 100B, a plurality of stages of the coupling parts 110 may be formed along the lamination direction of the metallic layers.

Thus forming the plurality of stages of the coupling parts 110 along the lamination direction of the metallic layers, it is possible to improve the mechanical coupling strength between the lower metallic part 101 and the upper metallic part 102.

Moreover, for example, as shown in FIG. 11, in the three-dimensional additive manufactured object 100B, the coupling parts 110 may be formed such that a cross-sectional area of a cross-section orthogonal to the lamination direction of the metallic layers in the coupling parts 110 formed by the plurality of stages gradually decreases upward along the lamination direction while repeatedly increasing and decreasing.

For example, in the three-dimensional additive manufactured object 100B shown in FIG. 11, the cross-sectional area of the cross-section orthogonal to the lamination direction of the metallic layers in the coupling parts 110 formed by the plurality of stages gradually decreases upward along the lamination direction while repeatedly increasing and decreasing. In other words, the above-described cross-sectional area in the coupling parts 110 gradually increases downward, that is, toward the lower metallic part 101 along the lamination direction while repeatedly increasing and decreasing.

In the coupling parts 110 formed by the plurality of stages, if the lower metallic part 101 and the upper metallic part 102 are pulled in a direction in which they are separated from each other, the coupling part 110 formed at a position close to the lower metallic part 101 bears, in addition to a load acting on itself, a load acting on the coupling part 110 formed at a position farther away from the lower metallic part 101 than itself. Thus, in terms of the strength of the coupling parts 110, the cross-sectional area of the cross-section orthogonal to the lamination direction of the metallic layers in the coupling parts 110 desirably increases toward the lower metallic part 101.

In this regard, in the three-dimensional additive manufactured object 100B shown in FIG. 11, since the above-described cross-sectional area in the coupling parts 110 gradually increases toward the lower metallic part 101 while repeatedly increasing and decreasing, it is possible to ensure the strength of the coupling parts 110 formed by the plurality of stages.

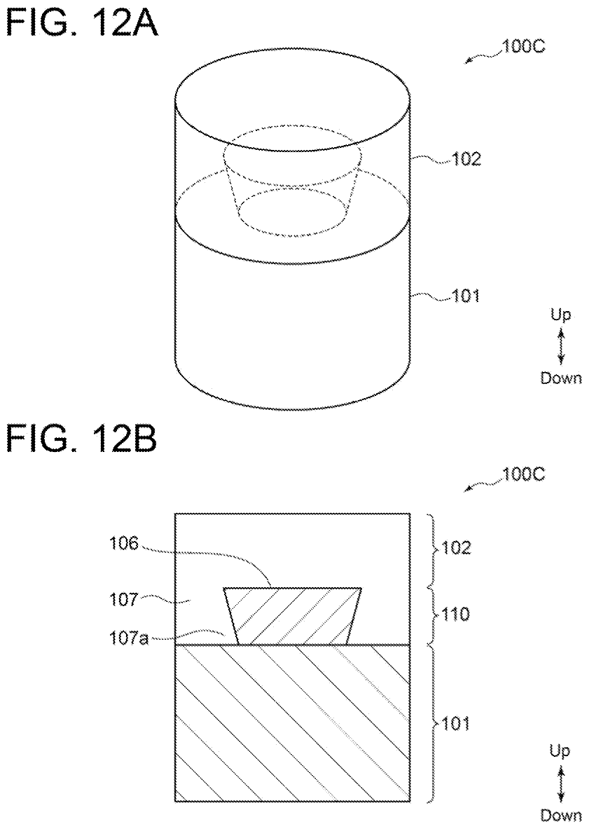

FIG. 12A is a view showing an example of another embodiment of the coupling part 110. FIG. 12B is a cross-sectional view of a three-dimensional additive manufactured object shown in FIG. 12A.

The coupling part (coupling region 106) in FIGS. 7A. 10, and 11 described above includes the reduced diameter portion 103 and the enlarged diameter portion 104 which are different in outer diameter. However, for example, as a three-dimensional additive manufactured object 100C shown in FIG. 12A, 12B, the coupling region 106 may be formed into a conical shape with an outer diameter gradually increasing upward from below.

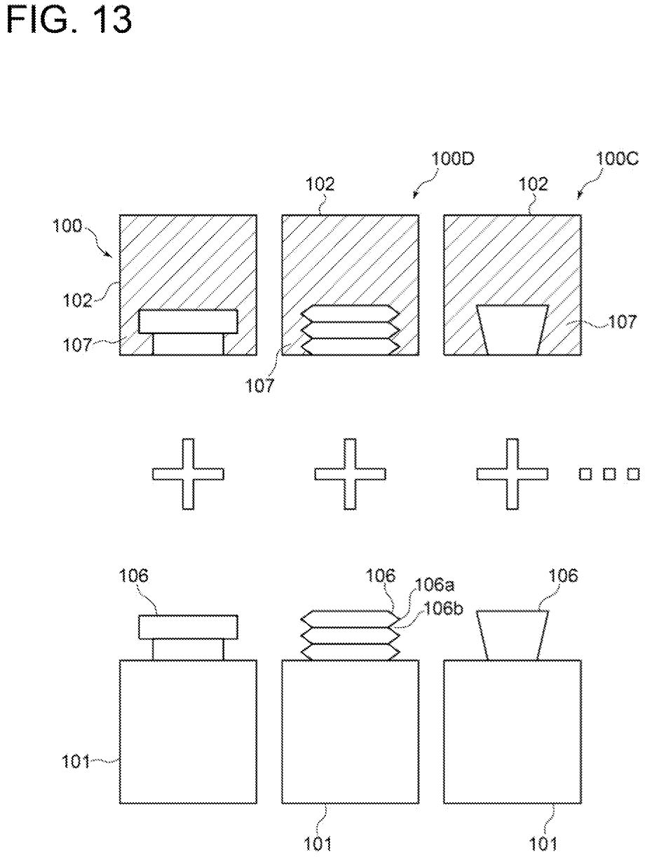

FIG. 13 shows views for each describing an example of a cross-sectional shape of the three-dimensional additive manufactured object according to some embodiments. The lower views in FIG. 13 are each a cross-sectional view of the lower metallic part 101 of the three-dimensional additive manufactured object according to some embodiments, and the upper views in FIG. 13 are each a cross-sectional view of the upper metallic part 102 of the three-dimensional additive manufactured object according to some embodiments. Moreover, the left views in FIG. 13 are views of the three-dimensional additive manufactured object 100 shown in FIG. 7A, and the right views in FIG. 13 are views of the three-dimensional additive manufactured object 100C shown in FIG. 12A. The lateral center views in FIG. 13 are views of a three-dimensional additive manufactured object 100D according to still another embodiment. The three-dimensional additive manufactured object 100D has a shape in which mountain portions 106a and valley portion 106b each having a smaller outer diameter than a corresponding one of the mountain portions 106a repeatedly appear along the lamination direction of the metallic layers, that is, the up-down direction.

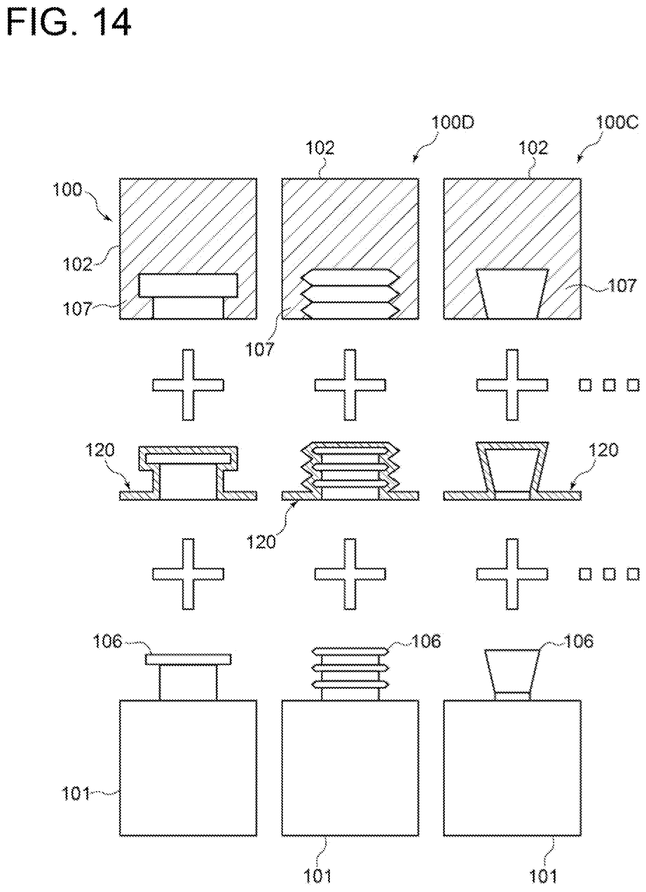

FIG. 14 shows views for, respectively, describing other embodiments of the three-dimensional additive manufactured objects according to some embodiments. The left views in FIG. 14 are views showing another embodiment of the three-dimensional additive manufactured object 100 shown in FIG. 7A, and the right views in FIG. 14 are views showing another embodiment of the three-dimensional additive manufactured object 100C shown in FIG. 12A. The lateral center views in FIG. 14 are views showing another embodiment of the three-dimensional additive manufactured object 100D shown in FIG. 13.

In the three-dimensional additive manufactured object according to some embodiments, as shown in FIG. 14, an insert member 120 is interposed between the coupling region 106 continued from the lower metallic part 101 and the coupling region 107 continued from the upper metallic part 102. Note that the insert member 120 may partially be disposed only on the coupling part. In a case in which the coupling part has a parallel cross structure, the insert member 120 may partially be disposed only on crossing sections.

In order to obtain the three-dimensional additive manufactured objects shown in FIG. 14, in the step of forming the coupling part 110 in the additive manufacturing method according to some embodiments, the coupling part 110 is preferably formed such that a third region (insert member 120), in which a plurality of third layers obtained by melting and solidifying powder of a metal (third metal) of a different type from the metal A and the metal B are laminated, is interposed between the coupling region 106 continued from the lower metallic part 101 and the coupling region 107 continued from the upper metallic part 102.

For example, in a case in which a significantly large number of intermetallic compounds are generated at the interface between the metal A composing the lower metallic part 101 and the metal B composing the upper metallic part 102, making it impossible to ensure the joint strength at the interface, a case in which the strength of the coupling region 106, 107 significantly decreases, or the like, it is preferable to insert the insert member 120 formed by a metal (such as the third metal) which is different from the metal A (such as the first metal) and the metal B (such as the second metal).

As the metal (may be referred to as a metal C, hereinafter) composing the insert member 120, it is possible to select a metal which does not generate a significantly large number of intermetallic compounds between the metal A and the metal B. If possible, it is desirable that the metal C composing the insert member 120 and the metal A, and the metal C composing the insert member 120 and the metal B satisfy at least one of the above-described condition (a1) or (b1).

That is, it is desirable that the metal C composing the insert member 120 and the metal A, and the metal C composing the insert member 120 and the metal B satisfy at least one of the following condition (a1-1), (a1-2), (b1-1), or (b1-2):

(a1-1) a combination capable of forming a solid solution, if one metal of the metal A or the metal C is added to the other metal;
(a1-2) a combination capable of forming a solid solution, if one metal of the metal B or the third metal C is added to the other metal;
(b1-1) if one metal of the metal A or the metal C is added to the other metal, a combination raising a melting point as an additive amount of the other metal increases; or
(b1-2) if one metal of the metal B or the metal C is added to the other metal, a combination raising a melting point as an additive amount of the other metal increases.

More specifically, if a decrease in strength in the vicinity of an interface between the metal A and the metal C is to be suppressed in a case in which the metal C is laminated on the metal A, it is preferable to adopt the above-described condition (a1-1), that is, the combination capable of forming the solid solution if the metal A is added to the metal C or the above-described condition (b1-1), that is, the combination raising the melting point as the additive amount of the metal A increases if the metal A is added to the metal C.

Moreover, if the decrease in strength in the vicinity of the interface between the metal A and the metal C is to be suppressed in a case in which the metal A is laminated on the metal C, it is preferable to adopt the above-described condition (a1-1), that is, the combination capable of forming the solid solution if the metal C is added to the metal A or the above-described condition (b1-1), that is, the combination raising the melting point as the additive amount of the metal C increases if the metal C is added to the metal A.

Likewise, if a decrease in strength in the vicinity of an interface between the metal B and the metal C is to be suppressed in a case in which the metal C is laminated on the metal B, it is preferable to adopt the above-described condition (a1-2), that is, the combination capable of forming the solid solution if the metal B is added to the metal C or the above-described condition (b1-2), that is, the combination raising the melting point as the additive amount of the metal B increases if the metal B is added to the metal C.

Moreover, if the decrease in strength in the vicinity of the interface between the metal B and the metal C is to be suppressed in a case in which the metal B is laminated on the metal C, it is preferable to adopt the above-described condition (a1-2), that is, the combination capable of forming the solid solution if the metal C is added to the metal B or the above-described condition (b1-2), that is, the combination raising the melting point as the additive amount of the metal C increases if the metal C is added to the metal B.

Thus, in the vicinity of the interface between the metal A and the metal composing the insert member 120 or in the vicinity of the interface between the metal B and the metal composing the insert member 120, the solid solution is formed, or the melting point in the vicinity of the interface is raised. Thus, it is possible to suppress formation of the fragile area by the intermetallic compound, making it possible to suppress the decrease in strength in the vicinity of the interface.

Moreover, if linear expansion coefficients are different between the metal A and the metal B, a thermal stress is generated in the vicinity of the interface where the metal A and the metal B contact, due to a temperature change of the joint member. Thus, in a case in which the difference in linear expansion coefficient between the metal A and the metal B is large, a value of the generated thermal stress is large as compared with a case in which the difference in linear expansion coefficient is small, easily decreasing the joint strength between the metal A and the metal B.

In this regard, according to the three-dimensional additive manufactured objects shown in FIG. 14, since the coupling part 110 is formed such that the insert member 120 is interposed between the coupling regions 106 and 107, it is possible to mitigate the thermal stress in the coupling region 106, 107 by, for example, selecting, as the third metal composing the insert member 120, a metal having a linear expansion coefficient of a value between the linear expansion coefficient of the metal A and the linear expansion coefficient of the metal B, or selecting a soft metal. Thus, it is possible to suppress the decrease in strength of the three-dimensional additive manufactured object.

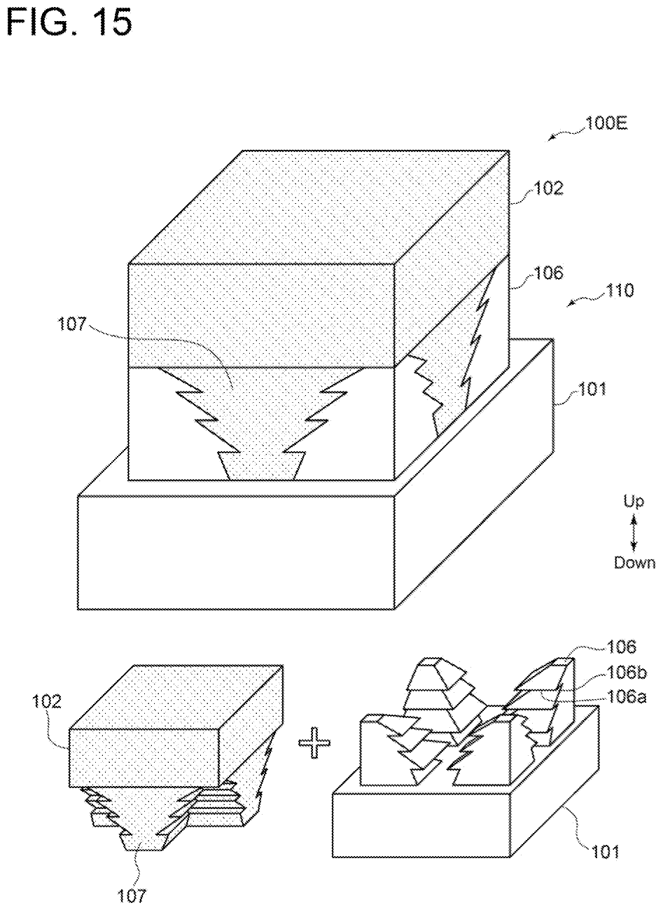

FIG. 15 shows views of an example of still another embodiment of the coupling part 110.

For example, as shown in FIG. 15, in a three-dimensional additive manufactured object 100E, as in the three-dimensional additive manufactured object 100D shown in FIG. 13, the coupling regions 106, each of which has the shape where the mountain portions 106a and the valley portion 106b each having the smaller outer diameter than the corresponding one of the mountain portions 106a repeatedly appear along the lamination direction of the metallic layers, that is, the up-down direction, may be disposed at a plurality of spots. Moreover, in the three-dimensional additive manufactured object 100E shown in FIG. 15, the respective shapes of the mountain portions 106a and the valley portions 106b as viewed from the up-down direction may each be a polygonal shape such as a rectangular shape, or may be a circular shape or an oval shape.

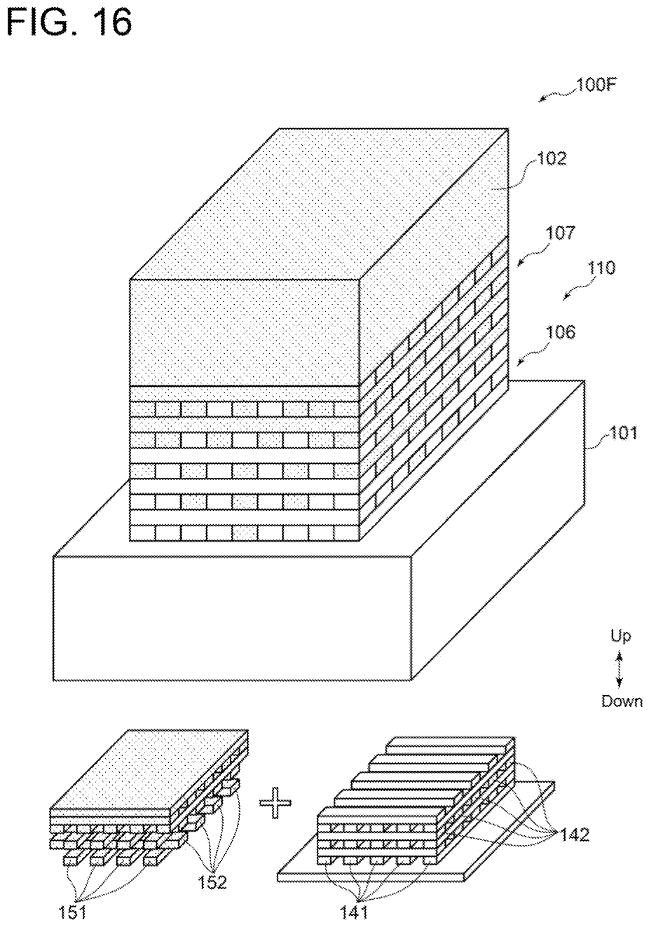

FIG. 16 shows views of an example of still another embodiment of the coupling part 110.

For example, as shown in FIG. 16, in a three-dimensional additive manufactured object 100F, the coupling regions 106, 107 may be formed into a parallel cross shape such that a parallel cross portion of the coupling region 106 and a parallel cross portion of the coupling region 107 fit each other. In FIG. 16, in order to simply express the respective shapes of the coupling regions 106, 107, the overall perspective view and the perspective views showing the parallel cross portions in FIG. 16 do not match in the number of stages of the beams and the number of parallel crosses in each stage.

In order to obtain the three-dimensional additive manufactured object 100F shown in FIG. 16, in the step of forming the coupling part 110 in the additive manufacturing method according to some embodiments, at least a part of the coupling region 106 continued from the lower metallic part 101 is formed such that a plurality of lower beams 141 and a plurality of upper beams 142 are arranged into a parallel cross shape. The lower beams 141 extend in a direction orthogonal to the lamination direction of the metallic layers, and the upper beams 142 extend in a direction orthogonal to the lamination direction of the metallic layers and crossing an extending direction of the lower beams 141, and is formed on top of the lower beams 141.

Moreover, in the step of forming the coupling part 110 in the additive manufacturing method according to some embodiments, at least a part of the coupling region 107 continued from the upper metallic part 102 is formed such that a plurality of lower beams 151 and a plurality of upper beams 152 are arranged into a parallel cross shape. The lower beams 151 extend in the direction orthogonal to the lamination direction of the metallic layers, and the upper beams 152 extend in a direction orthogonal to the lamination direction of the metallic layers and crossing an extending direction of the lower beams 151, and is formed on top of the lower beams 151.

Further, in the step of forming the coupling part 110 in the additive manufacturing method according to some embodiments, the lower beams 141 and the lower beams 151 are formed so as to extend in the same direction, and to be alternately arranged along a direction orthogonal to the extending direction of the lower beams 141 and the lower beams 151.

Furthermore, in the step of forming the coupling part 110 in the additive manufacturing method according to some embodiments, the upper beams 142 and the upper beams 152 are formed so as to extend in the same direction, and to be alternately arranged along a direction orthogonal to the extending direction of the upper beams 142 and the upper beams 152.

That is, in the step of forming the coupling part 110 in the additive manufacturing method according to some embodiments, the respective beams are formed such that one of the lower beams 141 in the coupling region 106 and one of the lower beams 151 in the coupling region 107 extend in the same direction, and one of the upper beams 142 in the coupling region 106 and one of the upper beams 152 in the coupling region 107 extend in the same direction.

Moreover, in the step of forming the coupling part 110 in the additive manufacturing method according to some embodiments, the lower beams 141 and the lower beams 151 are formed such that the other lower beams 141 in the coupling region 106 and the other lower beams 151 in the coupling region 107 are alternately arranged along the direction orthogonal to the extending direction of one of the lower beams 141 in the coupling region 106 and one of the lower beams 151 in the coupling region 107.

Furthermore, in the step of forming the coupling part 110 in the additive manufacturing method according to some embodiments, the upper beams 142 and the upper beams 152 are formed such that the other upper beams 142 in the coupling region 106 and the other upper beams 152 in the coupling region 107 are alternately arranged along the direction orthogonal to the extending direction of one of the upper beams 142 in the coupling region 106 and one of the upper beams 152 in the coupling region 107.

Thus, it is possible to mechanically couple the coupling region 106 and the coupling region 107 to each other directly by the coupling region 106 and the coupling region 107 formed by the crossing beams, in the coupling part 110. Accordingly, it is possible to ensure a strength of the three-dimensional additive manufactured object 100F serving as the joint member of the lower metallic part 101 and the upper metallic part 102, and to mitigate the thermal stress which is caused by the difference in linear expansion coefficient between the metal composing the lower metallic part 101 and the metal composing the upper metallic part 102.

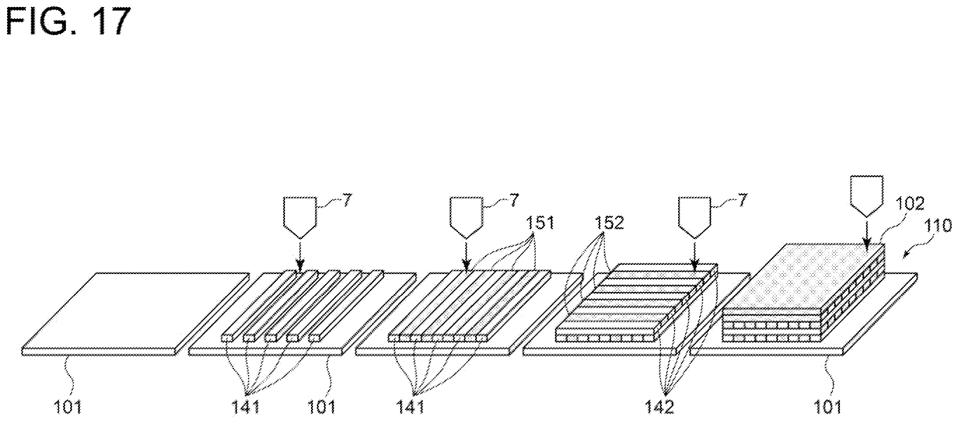

A formation method of the coupling region 106, 107 in the three-dimensional additive manufactured object 100F shown in FIG. 16 will be described with reference to FIG. 17. FIG. 17 shows views simplistically drawing the coupling region 106, 107 in order to describe the formation method of the coupling region 106, 107 in the three-dimensional additive manufactured object 100F shown in FIG. 16.

As in the left view of FIG. 17, the lower metallic part 101 composed of the metal A is formed by additive manufacturing. Then, as in the second left view of FIG. 17, the plurality of lower beams 141 composed of the metal A are formed to separate from each other in the direction orthogonal to the extending direction of the lower beams 141, on the upper surface of the lower metallic part 101.

Next, as in the third left view of FIG. 17, the lower beams 151 composed of the metal B are, respectively, formed in a plurality of spaces between the lower beams 141 separated from each other in the direction orthogonal to the extending direction of the lower beams 141.

Next, as in the fourth left view of FIG. 17, as with the case in which the lower beams 141, 151 are formed, the plurality of upper beams 142 composed of the metal A and the plurality of upper beams 152 composed of the metal B are formed on the lower beams 141, 151.

As described above, after the lower beams 141, 151 and the upper beams 142, 152 are formed by the desired number of stages, the upper metallic part 102 composed of the metal B is formed on the upper surface of the lower beams 141, 151 or the upper beams 142, 152 appeared on the uppermost side, as in the fifth left view of FIG. 17.

Thus forming the three-dimensional additive manufactured object 100F, it is possible to mechanically couple, that is, structurally couple the coupling regions 106, 107 formed into the parallel cross shape to each other, in the coupling part 110. Accordingly, it is possible to ensure the strength of the joint member of the lower metallic part 101 and the upper metallic part 102, and to mitigate the thermal stress caused by the difference in linear expansion coefficient between the metal A and the metal B.

For example, as shown in FIG. 17, in the three-dimensional additive manufactured object 100F, the coupling region 106 may be formed to include at least two pairs of the lower beams 141 and the upper beams 142 arranged into the parallel cross shape from the lower metallic part 101 toward the upper metallic part 102. In this case, the same number of pairs of the lower beams 151 and the upper beams 152 as the number of pairs of the lower beams 141 and the upper beams 142 in the coupling region 106 is preferably formed in the coupling region 107.

Thus, it is possible to increase the number of coupling stages in the coupling regions 106, 107 formed into the parallel cross shape, as compared with a case in which there is only one pair of the lower beam 141 and the upper beam 142 arranged in to the parallel cross shape. Thus, the thermal stress caused by the difference in linear expansion coefficient between the metal A and the metal B is mitigated easily.

Moreover, for example, as shown in FIG. 17, in the three-dimensional additive manufactured object 100F, the coupling part 110 may be formed such that a proportion of the coupling region 106 in a cross-section extending in the direction orthogonal to the lamination direction of the metallic layers in the coupling part 110 decreases from the lower metallic part 101 toward the upper metallic part 102.

More specifically, as shown in FIG. 17, the number of lower beams 141 and upper beams 142 may be reduced from the lower metallic part 101 toward the upper metallic part 102, and the width and the length of each of the lower beams 141 and the upper beams 142 as viewed from the lamination direction of the metallic layers may be decreased.

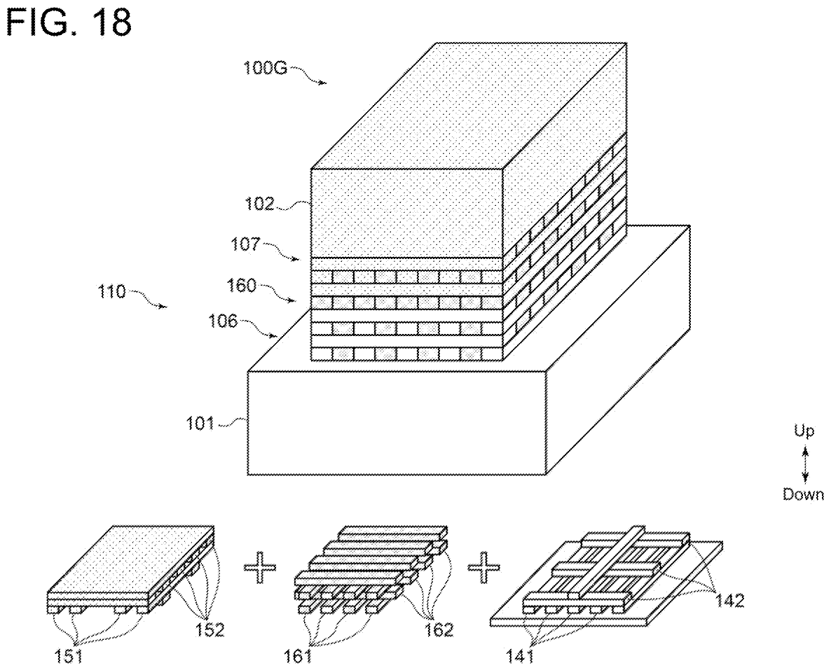

Similarly for the coupling region 107, the number of lower beams 151 and upper beams 152 may be reduced from the upper metallic part 102 toward the lower metallic part 101, and the width and the length of each of the lower beams 151 and the upper beams 152 as viewed from the lamination direction of the metallic layers may be decreased. As shown in FIG. 18 to be described later, regarding lower beams 161 and upper beams 162 in an insert member 160 and the lower beams 141 and the upper beams 142 in the coupling region 106, and regarding the lower beams 161 and the upper beams 162 in the insert member 160 and the lower beams 151 and the upper beams 152 in the coupling region 107, in the same light, the number of beams may be changed, and the width and the length of each beam may be changed.

Since the coupling part 110 is formed such that the proportion of the coupling region 106 in the cross-section extending in the direction orthogonal to the lamination direction of the metallic layers in the coupling part 110 decreases from the lower metallic part 101 toward the upper metallic part 102, it is possible to mitigate the thermal stress caused by the difference in linear expansion coefficient between the metal A and the metal B more effectively.

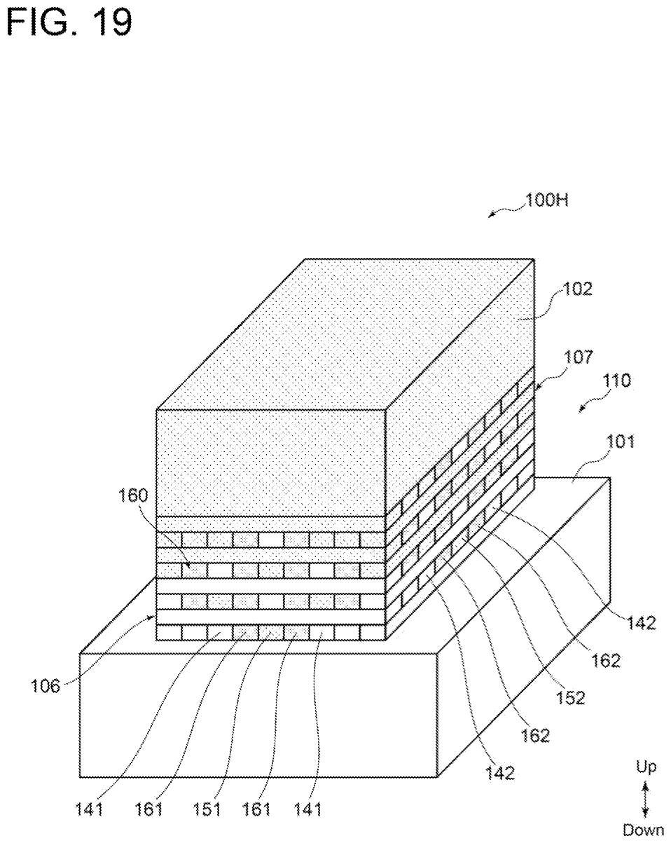

FIG. 18 shows views of an example in a case in which the insert member 120 as shown in FIG. 14 is applied to the three-dimensional additive manufactured object 100F shown in FIG. 16. Moreover, FIG. 19 is a view showing another example in the case in which the insert member 120 as shown in FIG. 14 is applied to the three-dimensional additive manufactured object 100F shown in FIG. 16.

For example, as shown in FIG. 18, the pairs of the lower beams 141 and the upper beams 142 arranged into the parallel cross shape as described above are formed in the coupling region 106 continued from the lower metallic part 101, and the pairs of the lower beams 151 and the upper beams 152 arranged into the parallel cross shape as described above are formed in the coupling region 107 continued from the upper metallic part 102.

Moreover, below the insert member 160 shown in FIG. 18, pairs of the lower beams 161 and the upper beams 162 composed of the metal (third metal) of the different type from the metal A and the metal B are formed to be fitted into the lower beams 141 and the upper beams 142 in the coupling region 106. Similarly, above the insert member 160 shown in FIG. 18, the pairs of the lower beams 161 and the upper beams 162 composed of the metal (third metal) of the different type from the metal A and the metal B are formed to be fitted into the lower beams 151 and the upper beams 152 in the coupling region 107.

In the example shown in FIG. 18, the coupling region 106 and the coupling region 107 are mechanically coupled to each other indirectly via the insert member 160. That is, in the example shown in FIG. 18, the coupling region 106 and the coupling region 107 are not in contact directly.

As a three-dimensional additive manufactured object 100H shown in FIG. 19, the lower beams 161 of the insert member 160 may, respectively, be arranged between the lower beams 141 of the coupling region 106 and the lower beams 151 of the coupling region 107 disposed in the direction orthogonal to the up-down direction, and the upper beams 162 of the insert member 160 may, respectively, be arranged between the upper beams 142 of the coupling region 106 and the upper beams 152 of the coupling region 107 disposed in the direction orthogonal to the up-down direction.

Note that the extending direction of the respective beams 141, 142, 151, 152, 161, 162 is not necessarily the direction orthogonal to the lamination direction of the metallic layers, but may be a direction crossing the lamination direction of the metallic layers at an angle other than 90 degrees.

Moreover, the lower beams 141 and the upper beams 142 may not necessarily be orthogonal to each other, but may cross at an angle other than 90 degrees. Similarly, the lower beams 151 and the upper beams 152 may not necessarily be orthogonal to each other, but may cross at an angle other than 90 degrees. Similarly, the lower beams 161 and the upper beams 162 may not necessarily be orthogonal to each other, but may cross at an angle other than 90 degrees.

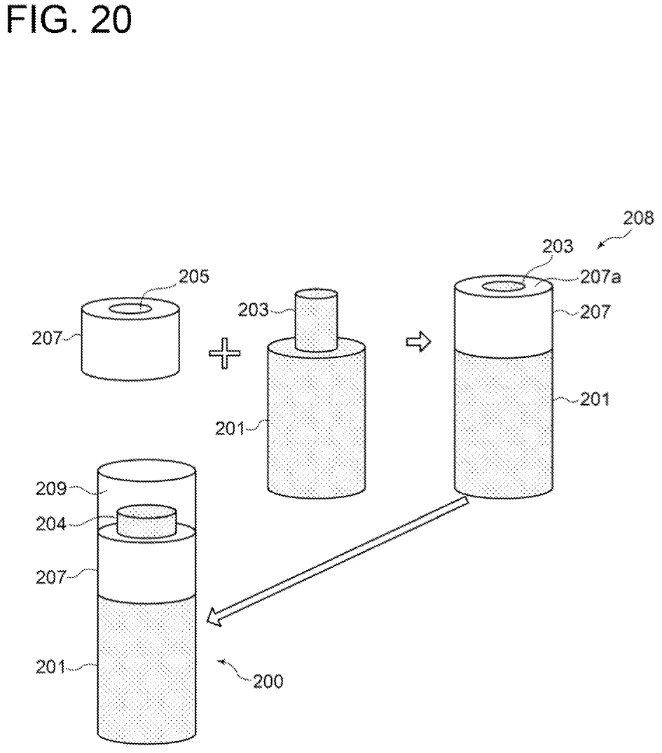

FIG. 20 shows schematic views for describing an example of a method of forming one joint object by coupling two members produced separately, by additive manufacturing.

For example, as shown in FIG. 20, an explanation will be given by taking an example of a case in which one joint object 200 is formed by coupling a first member 201 having a columnar projecting portion 203 and a second member 207 having a through hole 205 by additive manufacturing.

The first member 201 is composed of a metal D. Moreover, the second member 207 is composed of a metal E which is different from the metal D. The first member 201 may be formed by machining such as cutting or forging, may be formed by casting, or may be formed by additive manufacturing. The first member 201 may be obtained by further performing machining such as cutting or forging on a member formed by casting or additive manufacturing.

Similarly, the second member 207 may be formed by machining such as cutting, hole making, or forging, may be formed by casting, or may be formed by additive manufacturing. The second member 207 may be obtained by further performing machining such as cutting or forging on a member formed by casting or additive manufacturing.

The projecting portion 203 and the through hole 205 are formed so as to allow the projecting portion 203 to be inserted through the through hole 205. The projecting portion 203 may have not a columnar shape but a prismatic shape. Similarly, the through hole 205 may have not a circular cross-sectional hole but a rectangular cross-sectional hole.

The first member 201 and the second member 207 thus configured constitute an assembly 208 where the projecting portion 203 is inserted into the through hole 205 as shown in FIG. 20. Then, forming a layer by melting and solidifying powder of the metal D at a tip of the projecting portion 203 in the assembly 208 and in a region 207a around the through hole 205 of the surface of the second member 207, a large diameter portion 204 having a diameter larger than a diameter of the projecting portion 203 is formed. The large diameter portion 204 faces the region 207a of the second member 207 and bans movement of the second member 207 along the axial direction of the projecting portion 203. Moreover, the large diameter portion 204 is joined, on the lower surface thereof, with the region 207a of the second member 207, banning a rotation of the second member 207 about the projecting portion 203.

A third member 209 may be formed by additive manufacturing on the upper surface of the second member 207 and the upper surface of the large diameter portion 204 in the figure. The third member 209 may be composed of the metal D, may be composed of the metal E, or may be composed of a metal F which is different from the metal D and the metal E.

That is, a method of forming the joint object 200 shown in FIG. 20 includes a step of inserting, into the through hole 205 of the second member 207 which is a metallic part composed of the metal E, the columnar projecting portion 203 of the first member 201 which is a metallic part composed of the metal D of a different type from the metal E. Furthermore, the method of forming the joint object 200 shown in FIG. 20 includes a step of forming a layer by melting and solidifying the powder of the metal D at a tip of the projecting portion 203 inserted into the through hole 205 and at least a part of the region 207a around the through hole 205 of the surface of the second member 207.

Thus, it is possible to assemble and couple the first member 201 and the second member 207 created separately from each other.

In the above-described joint object 200, the first member 201 and the second member 207 are composed of the metals of the different types. However, the first member 201 and the second member 207 may be composed of a metal of the same type.

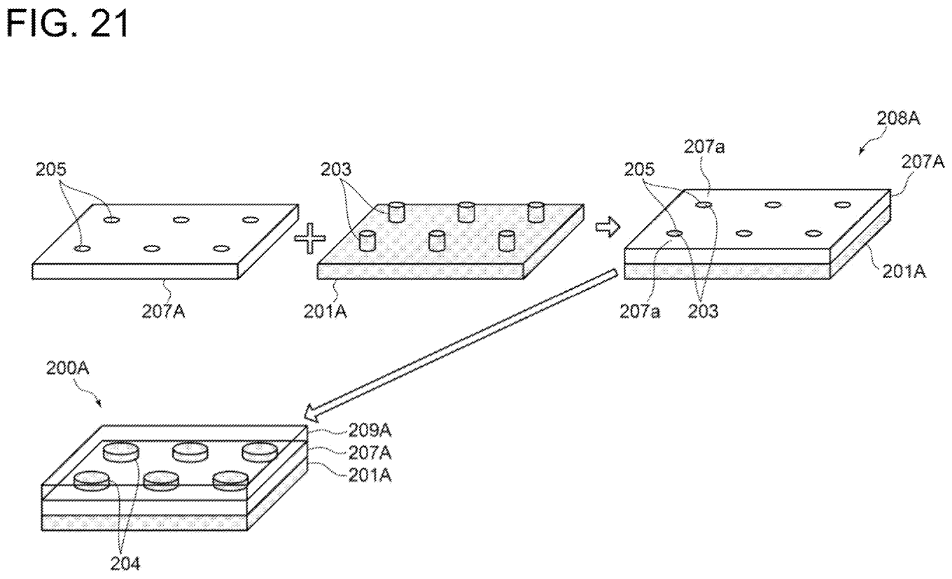

FIG. 21 shows schematic views for describing another example of the method of forming one joint object by coupling two members produced separately, by additive manufacturing.

For example, as shown in FIG. 21, an explanation will be given by taking an example of a case in which one joint object 200A is formed by coupling a first member 201A having a plurality of columnar projecting portions 203 and a second member 207A having a plurality of through holes 205, by additive manufacturing. The same configurations as those in the FIG. 20 described above are indicated by the same reference characters and may not be described in detail.

The first member 201A is composed of the metal D. Moreover, the second member 207A is composed of the metal E which is different from the metal D. The first member 201A may be formed by machining such as cutting or forging, may be formed by casting, or may be formed by additive manufacturing. The first member 201A may be obtained by further performing machining such as cutting or forging on a member formed by casting or additive manufacturing.

Similarly, the second member 207A may be formed by machining such as cutting, hole making, or forging, may be formed by casting, or may be formed by additive manufacturing. The second member 207A may be obtained by further performing machining such as cutting or forging on a member formed by casting or additive manufacturing.

As in the example shown in FIG. 20, the projecting portions 203 and the through holes 205 are formed so as to allow the projecting portions 203 to be inserted through the through holes 205, respectively.

The first member 201A and the second member 207A thus configured constitute an assembly 208A where the projecting portions 203 are inserted into the through holes 205, respectively, as shown in FIG. 21. Then, forming a layer by melting and solidifying the powder of the metal D at the respective tips of the projecting portions 203 in the assembly 208A and in the region 207a around the through holes 205 of the surface of the second member 207A, the large diameter portions 204 each having the diameter larger than the diameter of a corresponding one of the projecting portions 203 are formed. Each of the large diameter portions 204 faces the region 207a of the second member 207 and bans movement of the second member 207A along the axial direction of the corresponding one of the projecting portions 203. Moreover, each of the large diameter portions 204 is joined, on the lower surface thereof, with the region 207a of the second member 207A.

A third member 209A may be formed by additive manufacturing on the upper surface of the second member 207A and the respective upper surfaces of the large diameter portions 204 in the figure. The third member 209A may be composed of the metal D, may be composed of the metal E, or may be composed of the metal F which is different from the metal D and the metal E.

In the above-described joint object 200A, the first member 201A and the second member 207A are composed of the metals of the different types. However, the first member 201A and the second member 207A may be composed of a metal of the same type.

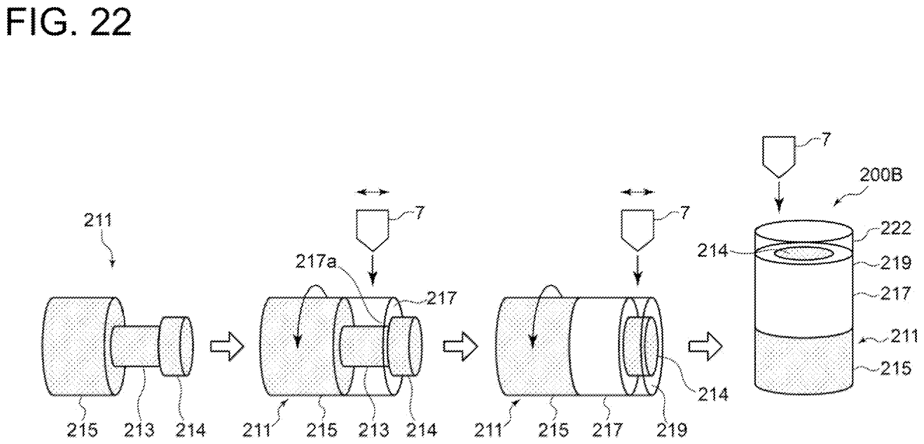

FIG. 22 shows schematic views for describing an example of a method of forming a portion with respect to a member produced in advance, by additive manufacturing.

For example, as shown in FIG. 22, an explanation will be given by taking a case in which a portion extending in an axis direction of a first member 211 is formed with respect to the first member 211 by additive manufacturing.

The first member 211 includes a cylindrical base portion 215, a first shaft-like portion 213 which has a base end connected to the base portion 215 and projects from the base portion 215, and a second shaft-like portion 214 connected to a tip of the first shaft-like portion 213 and having a larger diameter than the first shaft-like portion 213.

The first member 211 is composed of the metal D.

The first member 211 may be formed by machining such as cutting or forging, may be formed by casting, or may be formed by additive manufacturing. The first member 211 may be obtained by further performing machining such as cutting or forging on a member formed by casting or additive manufacturing.

Forming a layer by melting and solidifying powder of the metal E which is different from the metal D on the circumference of the first shaft-like portion 213 while rotating the first member 211 about the axis of the first shaft-like portion 213, a first cylindrical portion 217 is formed. Similarly, forming the layer by melting and solidifying the powder of the metal E on the circumference of the second shaft-like portion 214 while rotating the cylindrical base portion 215, a second cylindrical portion 219 is formed.

The second shaft-like portion 214 faces a region 217a on an end surface of the first cylindrical portion 217 and bans movement of the first cylindrical portion 217 along the axis of the first shaft-like portion 213. Moreover, the inner circumferential surfaces of the first cylindrical portion 217 and the second cylindrical portion 219 are joined with the outer circumferential surfaces of the first shaft-like portion 213 and the second shaft-like portion 214, respectively. Thus, rotations of the first cylindrical portion 217 and the second cylindrical portion 219 about the first shaft-like portion 213 and the second shaft-like portion 214 are banned, respectively.

A third member 222 may be formed by additive manufacturing on the end surface of the second shaft-like portion 214 and the end surface of the second cylindrical portion 219. The third member 222 may be composed of the metal D, may be composed of the metal E, or may be composed of the metal F which is different from the metal D and the metal E.

That is, the method of forming the joint object 200B shown in FIG. 22 includes a step of forming the layer on the first member 211 composed of the metal D, by melting and solidifying the powder of the metal E of the different type from the metal D. Then, the step of forming the layer includes forming the layer by melting and solidifying the powder of the metal Eon the respective circumferences of the first shaft-like portion 213 and the second shaft-like portion 214, while rotating the first member 211 about the axis of the first shaft-like portion 213.

Thus, it is possible to form the layer by melting and solidifying the power of the metal E on the respective circumferences of the first shaft-like portion 213 and the second shaft-like portion 214, even if the diameter of the base portion 215 connected to the base end of the first shaft-like portion 213 is larger than the diameter of the first shaft-like portion 213, and the second shaft-like portion 214 having the larger diameter than the first shaft-like portion 213 is formed at the tip of the first shaft-like portion 213.

In the above-described joint object 200, the first member 211, and the first cylindrical portion 217 and the second shaft-like portion 214 are composed of the metals of the different types. However, the first member 211, and the first cylindrical portion 217 and the second shaft-like portion 214 may be composed of a metal of the same type. Moreover, the first cylindrical portion 217 and the second shaft-like portion 214 may be composed of metals of different types, respectively.

The present invention is not limited to the above-described embodiments, and also includes an embodiment obtained by modifying the above-described embodiments and an embodiment obtained by combining these embodiments as appropriate.

For example, in the embodiment of some embodiments described above with the coupling part 110 achieving mechanical coupling, it is possible to ensure the strength of the joint member without relying on the joint strength at the interface between metals of different types. Therefore, in the embodiment of some embodiments described above with the coupling part 110 achieving mechanical coupling, the joint strength at the interface between the metals of the different types may not necessarily be ensured.

### REFERENCE SIGNS LIST

1 Three-dimensional additive manufacturing device
21 First metallic part
21a First layer
22 Second metallic part
22a Second layer
100, 100A-100H Three-dimensional additive manufacturing device
101 Lower metallic part
102 Upper metallic part
106, 107 Coupling region
110 Coupling part
120, 160 Insert member

1. An additive manufacturing method of a joint object, comprising:
a step of forming a first layer by melting and solidifying powder of a first metal; and
a step of forming a second layer on the first layer by melting and solidifying powder of a second metal of a different type from the first metal,
wherein the first metal and the second metal are:
if the first metal is added to the second metal, a combination capable of forming a solid solution; or
if the first metal is added to the second metal, a combination raising a melting point as an additive amount of the first metal increases.

2. The additive manufacturing method of the joint object according to claim 1,
wherein the first metal and the second metal are selected, which are the combination capable of forming the solid solution or the combination raising the melting point.

3. The additive manufacturing method of the joint object according to claim 1,
wherein the step of forming the second layer includes forming the second layer on a processing condition in which a content of the first metal in the second layer is not more than a limit capable of forming the solid solution.

4. The additive manufacturing method of the joint object according to claim 1, further comprising:
a step of forming a second metallic part composed of the second metal;
a step of forming a first metallic part composed of the first metal on the second metallic part; and
a step of forming a coupling part including a first region and a second region, for coupling the first metallic part and the second metallic part by the first region and the second region, the first region being a region in which a plurality of first layers are laminated and connected to the first metallic part, the second region being a region in which a plurality of second layers are laminated and connected to the second metallic part,
wherein the step of forming the coupling part includes forming the first region and the second region such that a part of the second region is positioned above a part of the first region.

5. The additive manufacturing method of the joint object according to claim 4,
wherein the step of forming the coupling part includes forming the second region such that a shape thereof as viewed from a lamination direction of the plurality of second layers is an oval shape or a polygonal shape.

6. The additive manufacturing method of the joint object according to claim 4,
wherein the step of forming the coupling part includes forming the coupling part at each of a plurality of positions which are different positions as viewed from a lamination direction of the plurality of second layers.

7. The additive manufacturing method of the joint object according to claim 6,
wherein the step of forming the coupling part includes forming the coupling part at each of at least three spots which are positions not in a same straight line as viewed from the lamination direction of the plurality of second layers.

8. The additive manufacturing method of the joint object according to claim 4,
wherein the step of forming the coupling part includes forming a plurality of stages of coupling parts along a lamination direction of the plurality of second layers.

9. The additive manufacturing method of the joint object according to claim 8,
wherein the step of forming the coupling part includes forming the second region such that a cross-sectional area of a cross-section orthogonal to the lamination direction of the plurality of second layers of the second region in the coupling parts formed by the plurality of stages gradually decreases upward along the lamination direction.

10. The additive manufacturing method of the joint object according to claim 4,
wherein the second region includes:
a second lower region formed on the second metallic part, in which a cross-sectional area of a cross-section orthogonal to a lamination direction of the second region is smaller than a cross-sectional area of the second metallic part; and
a second upper region which is formed on the second lower region, is smaller than the cross-sectional area of the second metallic part, and is larger than a cross-sectional area of the second lower region,
wherein the first region includes a first lower region surrounding the second lower region from a direction orthogonal to the lamination direction, and
wherein the step of forming the coupling part includes forming the first lower region before forming the second lower region.

11. The additive manufacturing method of the joint object according to claim 10,
wherein the step of forming the coupling part includes forming the second lower region at a position away from the first lower region first, in the forming of the second lower region.

12. The additive manufacturing method of the joint object according to claim 10,
wherein the step of forming the coupling part includes laminating the first layer at a position of a same height as the first layer and away from the second upper region first, before forming the first layer on top of the second upper region.

13. The additive manufacturing method of the joint object according to claim 4,
wherein the step of forming the coupling part includes forming the coupling part such that a third region is interposed between the first region and the second region, the third region including a plurality of laminated third layers obtained by melting and solidifying powder of a third metal of a different type from the first metal and the second metal.

14. The additive manufacturing method of the joint object according to claim 13,
wherein the first metal, the second metal, and the third metal are any one of:
if one metal of the first metal or the third metal is added to the other metal, a combination capable of forming a solid solution;
if one metal of the second metal or the third metal is added to the other metal, a combination capable of forming a solid solution;
if one metal of the first metal or the third metal is added to the other metal, a combination raising a melting point as an additive amount of the other metal increases; or
if one metal of the second metal or the third metal is added to the other metal, a combination raising a melting point as an additive amount of the other metal increases.

15. An additive manufacturing method of a joint object, comprising:
a step of forming a fourth metallic part composed of a fourth metal;
a step of forming a fifth metallic part composed of a fifth metal of a different type from the fourth metal on the fourth metallic part; and
a step of forming a coupling part including a fourth region and a fifth region, for coupling the fourth metallic part and the fifth metallic part by the fourth region and the fifth region, the fourth region being a region, in which a plurality of fourth layers obtained by melting and solidifying powder of the fourth metal are laminated, and connected to the fourth metallic part, the fifth region being a region, in which a plurality of fifth layers obtained by melting and solidifying powder of the fifth metal are laminated, and connected to the fifth metallic part,
wherein the step of forming the coupling part includes forming the fourth region and the fifth region such that a part of the fourth region is positioned above a part of the fifth region.

16. The additive manufacturing method of the joint object according to claim 15,
wherein in the fourth layers, a plurality of layers are laminated, which are a group of linear beads formed by melting and solidifying the powder of the fourth metal, and
wherein the step of forming the coupling part includes decreasing a thickness of each of the beads or reducing a width of each of the beads in forming of a layer close to an interface with the fifth region as compared with forming of a layer far away from the interface, in the forming of the fourth region positioned above the part of the fifth region.

17. The additive manufacturing method of the joint object according to claim 15,
wherein the step of forming the coupling part includes:
forming at least a part of the fourth region such that a plurality of fourth lower beams and a plurality of fourth upper beams are arranged, the fourth lower beams extending in a direction crossing a lamination direction of the fourth layers, the fourth upper beams extending in a direction orthogonal to the lamination direction of the fourth layers and crossing an extending direction of the fourth lower beams, and being formed on top of the fourth lower beams;
forming at least a part of the fifth region such that a plurality of fifth lower beams and a plurality of fifth upper beams are arranged, the fifth lower beams extending in a direction crossing a lamination direction of the fifth layers, the fifth upper beams extending in a direction crossing the lamination direction of the fifth layers and crossing an extending direction of the fifth lower beams, and being formed on top of the fifth lower beams; and
extending one of the fourth lower beams and one of the fifth lower beams in a same direction, and extending one of the fourth upper beams and one of the fifth upper beams in a same direction.

18. The additive manufacturing method of the joint object according to claim 17,
wherein the fourth lower beams and the fifth lower beams are formed such that the other fourth lower beams and the other fifth lower beams are alternately arranged along a direction crossing an extending direction of one of the fourth lower beams and one of the fifth lower beams, and
wherein the fourth upper beams and the fifth upper beams are formed such that the other fourth upper beams and the other fifth upper beams are alternately arranged along a direction crossing an extending direction of one of the fourth upper beams and one of the fifth upper beams.

19. The additive manufacturing method of the joint object according to claim 17,
wherein the step of forming the coupling part includes forming the fourth region such that at least two pairs of the fourth upper beams and the fourth lower beams are included from the fourth metallic part toward the fifth metallic part.

20. The additive manufacturing method of the joint object according to claim 19,
wherein the step of forming the coupling part includes forming the coupling part such that a proportion of the fourth region in a cross-section extending in the direction crossing the lamination direction of the fourth layers in the coupling part decreases from the fourth metallic part toward the fifth metallic part.

21. An additive manufacturing method of a joint object, comprising:
a step of inserting, into a through hole of a sixth metallic part composed of a sixth metal, a columnar projecting portion of a seventh metallic part composed of a seventh metal of a different type from the sixth metal; and
a step of forming a layer by melting and solidifying powder of the seventh metal at a tip of the projecting portion inserted into the through hole and at least a part of a region around the through hole of a surface of the sixth metallic part.

22. An additive manufacturing method of a joint object, comprising:
a step of forming a layer on an eighth member composed of an eighth metal, by melting and solidifying powder of a ninth metal of a different type from the eighth metal,
wherein the eighth member includes:
a base portion;
a first shaft-like portion which has a base end connected to the base portion and projects from the base portion; and
a second shaft-like portion connected to a tip of the first shaft-like portion and having a larger diameter than the first shaft-like portion, and
wherein the step of forming the layer includes forming a layer by melting and solidifying the powder of the ninth metal on respective circumferences of the first shaft-like portion and the second shaft-like portion, while rotating the eighth member about an axis of the first shaft-like portion.

23. A joint member, comprising:
a fourth metallic part composed of a fourth metal;
a fifth metallic part formed on the fourth metallic part and composed of a fifth metal of a different type from the fourth metal; and
a coupling part including a fourth region and a fifth region, for coupling the fourth metallic part and the fifth metallic part by the fourth region and the fifth region, the fourth region being formed by the fourth metal and connected to the fourth metallic part, the fifth region formed by the fifth metal and connected to the fifth metallic part,
wherein in the coupling part, a part of the fourth region is positioned above a part of the fifth region.
